(19) United States
(12) Patent Application Publication
(10) Pub. No.: US 2026/0346370 A1
(43) Pub. Date: Nov. 5, 2026

(54) LASER MARKING SYSTEM AND METHOD FOR MARKING A CURVED SURFACE

(71) Applicant: InPhocal B.V., Eindhoven (NL)

(72) Inventors: Martijn Joseph BOERKAMP, Eindhoven (NL); Yu-Xuan CHUANG, Eindhoven (NL)

(73) Assignee: InPhocal B.V., Eindhoven (NL)

(21) Appl. No.: 19/478,327

(22) PCT Filed: Apr. 17, 2024
(86) PCT No.: PCT/NL2024/050197

§ 371 Date: Oct. 24, 2025

(30) Foreign Application Priority Data
Apr. 25, 2023 (NL) 2034686

(51) Int. Cl. B23K 26/082; B23K 26/362; B23K 101/00; G01B 11/24

(52) U.S. Cl. CPC B23K 26/082; B23K 26/362; G01B 11/24; B23K 2101/007

(57) ABSTRACT

A laser marking system and method for marking a curved surface. An optical assembly is configured to project a laser beam onto the curved surface for applying the marking. The optical assembly comprises beam steering optics configured to determine a variable position at which the projected laser beam intersects the curved surface. A beam controller configured to control the beam steering optics based on a control algorithm. The control algorithm is configured to receive an input image comprising a set of two-dimensional input coordinates representing nodes of the marking as it is intended to appear on the curved surface, receive a curvature map representing a three-dimensional curvature of the curved surface, calculate a set of two-dimensional output coordinates based on the set of two-dimensional input coordinates and the curvature map, and control the position of the laser beam based on the set of the two-dimensional output coordinates.

### TECHNICAL FIELD AND BACKGROUND

The present disclosure relates to a laser marking system and method for marking a curved surface. The method may be performed in accordance with a control algorithm stored on a computer readable medium.

Laser marking typically involves using a laser beam to alter the surface of a material, e.g., through thermal effects and/or induced chemical effects. Laser marking can be used as an alternative to ink and stickers to label information like expiry date, barcode, logo, et cetera on products. This may alleviate material waste. However, techniques for laser marking products having curved surfaces may be cumbersome and result in distortion of the image. This may be especially challenging for marking products having variable surface curvature, e.g. fruit or other consumable products.

There is accordingly a need for further improvement of laser marking systems and methods for marking a curved surface.

### SUMMARY

According to a first aspect, the present disclosure provides a laser marking system for marking a curved surface. The system comprises an optical assembly configured to project a laser beam onto the curved surface for applying the marking. The optical assembly comprises beam steering optics configured to determine a variable position at which the projected laser beam intersects the curved surface. A beam controller is configured to control the beam steering optics based on a control algorithm. The control algorithm is configured to receive an input image comprising a set of two-dimensional input coordinates representing nodes of the marking as it is intended to appear on the curved surface, receive a curvature map representing a three-dimensional curvature of the curved surface, calculate a set of two-dimensional output coordinates based on the set of two-dimensional input coordinates and the curvature map, and control the position of the laser beam based on the set of the two-dimensional output coordinates.

According to a second aspect, the present disclosure provides a method for marking a curved surface. The method comprises using an optical assembly to project a laser beam onto the curved surface for applying the marking. The optical assembly comprises beam steering optics configured to determine a variable position at which the projected laser beam intersects the curved surface. A beam controller is used to control the beam steering optics based on a control algorithm. The control algorithm is configured to receive an input image comprising a set of two-dimensional input coordinates representing nodes of the marking as it is intended to appear on the curved surface, receive a curvature map representing a three-dimensional curvature of the curved surface, calculate a set of two-dimensional output coordinates based on the set of two-dimensional input coordinates and the curvature map, and control the position of the laser beam based on the set of the two-dimensional output coordinates.

According to a third aspect, the present disclosure provides a (non-transitory) computer-readable medium storing instructions including a control algorithm that, when executed by the beam controller in the system or method as described herein, causes the beam controller to receive an input image comprising a set of two-dimensional input coordinates representing nodes of the marking as it is intended to appear on the curved surface, receive a curvature map representing a three-dimensional curvature of the curved surface, calculate a set of two-dimensional output coordinates based on the set of two-dimensional input coordinates and the curvature map, and control the position of the laser beam based on the set of the two-dimensional output coordinates.

Preferably, the set of two-dimensional output coordinates is adapted with respect to the set of input coordinates to compensate for a distortion of relative distances between the nodes in the projecting of the laser beam onto the curved surface. In one embodiment, a pair output coordinates in the set of output coordinates is calculated by determining, in the set of input coordinates, a pair of input coordinates corresponding to a pair of nodes which are closest neighbors in the input image. In another or further embodiment, the calculating comprises determining, based on the pair of input coordinates, a Euclidian length of a straight line segment along a flat plane of the input image between the pair of nodes. In another or further embodiment, the calculating comprises determining a pair of projected coordinates based on a calculated projection of the pair of input coordinates onto the curvature map in accordance with the projection of the laser beam by the optical assembly via the beam steering optics onto the curved surface. In another or further embodiment, the calculating comprises determining a geodesic length of a curved line segment between the pair of projected coordinates along a manifold of the surface map. For example, the geodesic length of the curved line segment can be calculated using a line integral. In another or further embodiment, the calculating comprises adapting the pair of output coordinates with respect to the pair input coordinates to minimize a difference between the geodesic length of the curved line segment along the manifold of the curvature map relative to the Euclidian length of the straight line segment along the along the flat plane of the input image. Preferably, each input coordinate in the set of input coordinates is part of at least one respective pair of input coordinates, and adapted into a corresponding pair of output coordinates. Most preferably, the set of output coordinates is adapted with respect to the set of input coordinates to minimize an overall distortion between the respective lengths of the curved line segment relative to the respective lengths of the straight line segments. Optionally, one of the geodesic length and the Euclidian length is scaled by an overall scaling parameter which is the same for the calculation of all output coordinates. For example, the projected image may be overall larger than the input image.

In a preferred embodiment, the three-dimensional curvature of the curved surface is mapped using parameterized line segments such as splines. Most preferably the curvature map comprises a NURBS surface (“Non-Uniform Rational Basis Spline”).

In some embodiments, a scanner is configured to scan the three-dimensional curvature of the curved surface for determining the curvature map. In one embodiment, the scanner is configured to scan a scanner beam over the curved surface, and determine the three-dimensional curvature based on the scanner beam. For example, a scanning technique such as LIDAR and/or Time of Flight can be used. In a particularly advantageous embodiment, the scanner beam is scanned using the same beam steering optics as used for projecting the laser beam onto the curved surface, wherein the scanner beam is scanned over the curved surface to determine the curvature map prior to applying the marking onto the curved surface based on the determined curvature map. Also a separate scanner and/or other scanning techniques can be used, based on beam scanning or otherwise.

In some embodiments, the optical assembly comprises focusing optics configured to focus the laser beam onto the curved surface. Preferably, the focusing optics comprise at least one spherical optical element configured to introduce spherical aberrations into the focusing beam. Advantageously, the spherical aberrations may be configured to maximize a length of a focal region of the focused beam such that the focal region coincides with the curved surface for each position of the beam as determined by the beam steering optics. Most preferably, the focusing optics comprise at least a first optical element having at least one spherical surface introducing a first set of spherical aberrations into the beam, and a second optical element having at least one spherical surface introducing second set of spherical aberrations into the beam, wherein the second optical element is arranged at a distance from the first optical element, wherein the different sets of spherical aberrations are tuned to mutually interfere for maximizing the length of the focal region.

These and other features, aspects, and advantages of the apparatus, systems and methods of the present disclosure will become better understood from the following description, appended claims, and accompanying drawing.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1a illustrates laser marking with short depth of focus;

FIG. 1b illustrates laser marking with long depth of focus;

FIG. 2 illustrates a setup for laser marking;

FIG. 3 illustrates 2D information (top “ACB”) and a distorted mark after marking onto 3D surface (bottom “ABC”);

FIG. 4 illustrates a flattened sphere with complex shape;

FIG. 5 illustrates (left) a triangulated salt dome, and (right) parameterization of the salt dome;

FIG. 6 illustrates affine mapping;

FIG. 7 illustrates a Bessel beam created by an axicon;

FIG. 8 illustrates an optical system with a ball lens and an expander lens to generate structure beams;

FIG. 9 illustrates on the top a profile (left), intensity distribution and full width at half maximum (middle), full width at half maximum (FWHM) is denoted indicated), and the energy ratio encircled within a given radius (right) on the cross-section plane of the structured beam (SB) achieved by the applicant; and on the bottom a compared beam;

FIG. 10 illustrates a visualization of Basis function with order p=0, 1, 2 and knot vector U={0, 1, 2, 3, 4, 5, . . . };

FIG. 11 illustrates a sinusoidal curve constructed by NURBS with control points (dots), knot vector U={0.0, 0.1, 0.2, . . . , 1.0} (cross) and corresponding point of each knot (square);

FIG. 12 illustrates (top) mapping line segments with the same length on a sinusoidal curve through orthogonal projection, and (bottom) Pattern mapping through orthogonal projection to show the distortion in (a) and through NURBS with p=2 and wi=1 for all i to eliminate this distortion in (b);

FIG. 13 illustrates slicing sample points of a sinusoidal surface along (left) i direction and (right) j direction

FIG. 14 illustrates sinusoidal surface reconstructed through NURBS with control points (dots), knot vectors U and V (cross), corresponding point of knots (square), order p, q=3 and wi,j=1 for all i, j;

FIG. 15 illustrates (left) a sinusoidal surface reconstructed through NURBS with 9×9 sample points, and (right) a sinusoidal surface reconstructed through NURBS with 4×4 sample points;

FIG. 16 illustrates line segment s(u(t), v(t)) mapped onto a sinusoidal surface with start point (0.25, 0.25) and endpoint (0.75, 0.75) in U, V knot vectors span;

FIG. 17 illustrates a 3D human face surface model with sampling points;

FIG. 18 illustrates the 3D human face surface model rearranged;

FIG. 19 illustrates (top) slices and projection plane of the 3D human face surface model, and (bottom) points selection of the 3D human face surface model for NURBS surface reconstruction;

FIG. 20 illustrates reconstructed points S(u, v) for u=0, 0.01, . . . , 0.99, 1 and v=0, 0.01, . . . , 0.99, 1 of the 3D human face surface model through NURBS;

FIG. 21 illustrates an NURBS Surface Reconstruction algorithm;

FIG. 22 illustrates a new NURBS Surface Reconstruction algorithm;

FIG. 23 illustrates a mapped Iso-parametric line u=0.5 and v=0.5 in (left) the knot vectors span and (right) onto the 3D human face surface model;

FIG. 24 illustrates a Data Select Zero Padding algorithm;

FIG. 25 illustrates zero padding to 3D human face surface model with scanning area 334×334;

FIG. 26 illustrates Mapped Iso-parametric line u=0.5 and v=0.5 in (left) the knot vectors span and (right) onto the 3D human face surface model;

FIG. 27 illustrates a Mapping Domain algorithm;

FIG. 28 illustrates the mapping area of 3D human face surface model created by (11×11) points;

FIG. 29 illustrates a square with side length 30 mapped onto the 3D human face surface model (left) before applying shape correction and (right) after using shape correction;

FIG. 30 illustrates sketches of different ways to acquire the shape of an object;

FIG. 31 illustrates a detected mandarin surface (left) before filtering and (right) after filtering;

FIGS. 32-34 illustrate simulations of mapping patterns onto a mandarin's surface;

FIG. 35 illustrate actual marking result on a mouse's surface by using the laser marking system described herein;

FIG. 36 illustrates (top) a corrected pattern for being imported into software and controlling the galvanometric scanner to mark on the mouse, and (bottom) the uncorrected pattern;

FIGS. 37-39 illustrate simulations of mapping patterns onto a mandarin's surface;

FIG. 40 illustrate actual marking result on a mandarin's surface by using the laser marking system described herein;

FIG. 41 illustrates (left) a corrected pattern for being imported into software and controlling the galvanometric scanner to mark on the mandarin, and (right) the uncorrected pattern;

FIG. 42 illustrates effects of the number of subintervals in Simpson's rule on the shape correction error;

FIG. 43 illustrates effects of the number of points to create the mandarin's mapping domain on the shape correction error;

FIG. 44 illustrates effects of the number of points to create the mouse's mapping domain on the shape correction error;

FIG. 45 illustrates a table of time consumption, total length difference el and total area error ea comparison by using different methods of shape correction in mapping on the mandarin's surface;

FIG. 46 illustrates time consumption, total length difference el and total area error ea comparison by using different methods of shape correction in mapping on the mouse's surface.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

Laser processing involves using a laser beam to alter the surface of a material through thermal effects, including laser welding, laser cutting, surface modification, laser marking, laser drilling, and micro-processing. The laser beam can be used to perform various tasks, such as punching, cutting, scribing, welding, and heat treatment, on different materials.

Optical modules to generate laser beams with a long depth of focus are advantageous for laser marking systems. Due to the long depth of focus, 3-dimensional curved surfaces can be marked without changing the distance between the target surface and the laser marking system, accomplishing high-speed 3D laser marking.

Nowadays, people use ink and stickers to label information like expiry date, barcode, logo, etc on products, which causes a serious environmental problem. On the other hand, laser marking will not produce extra waste, making it a sustainable way to do the labelling. However, laser marking will project 2-dimensional patterns onto the 3-dimensional surfaces orthogonally, and these patterns will be inevitably distorted. Currently, to map 2-dimensional patterns onto 3-dimensional surfaces, surface parameterization is used. By finding the 2-dimensional parameterized plane of the target surface and putting a 2-dimensional pattern onto this plane, this pattern can be mapped by reversing the parameterized plane as well as the 2-dimensional pattern to the original 3-dimensional surface. Then, by extracting the x and y coordinates of the mapped pattern, a 2-dimensional corrected pattern is obtained and can be marked on the curved surface without distortion. This method has some issues, making it take too long for correcting patterns for doing laser marking in the production line.

A new method based on non-uniform rational b-spline (NURBS) is presented in order to provide a fast and precise method to get the corrected pattern.

Light Amplification by Stimulated Emission of Radiation (Laser) is electromagnetic radiation emitted by stimulating atoms or molecules. In Atomic theory, electrons orbit randomly around the atomic nucleus and the distances between the atomic nucleus and electrons depend on its energy level. If an electron is stimulated by the external energy, it can be excited to a higher energy level. When this electron falls back to a lower energy level, it will emit radiation with energy equal to the energy difference between this high and low energy level. In a laser, the electrons of the gain medium will get stimulated by a pumping energy, and when the excited electrons fall back to the lower energy level, they will emit photons. However, if the electrons emitted photons through spontaneous emission, the photons will have low coherence. To solve this, the laser uses the metastability of electrons. The electrons in a meta-stable state will be less likely to have spontaneous emission, but more likely to emit photons when other photons pass through them, and the emitted photons will have the same wavelength as the passed-through photons. This process is also known as stimulated emission. Then, these emitted photons will be bounced back and forth between the high reflector (a mirror) and the output coupler (a partially transparent mirror) and make stimulated emission occur again and again to get more photons to form a laser beam and go out from the output coupler. The light beam coming out of the laser will have high coherence, low divergence, and high power density within a small spot.

Due to these characteristics, lasers are widely used in the industrial sector, from leaving visible markings on the materials to even cutting through the materials. Since laser processing is a process to make materials melt or evaporate by absorbing the energy from the laser beam, the absorption rate of materials, which is related to the wavelength of the laser beam, plays an important role in laser processing. However, the wavelength of the laser beam can be manipulated by applying different gain mediums (e.g. CO2 laser with wavelength 10600 nm can be used in processing organic materials, and Nd: YAG laser with wavelength 1064 nm can be used in processing metals), making laser processing extraordinary flexible and it can be used for almost all materials.

Besides, Laser processing is a non-contact machining method, so it gets rid of the cutting tool wear in traditional machining methods, thereby reducing the cost and time-consuming need of replacing cutting tools. Even more, with the laser marking machine, information about products such as expiration dates, bar codes, or logos (this “information” will be represented by “pattern” in the rest of this document), can be printed directly without ink and stickers, which are the dominant way to show such patterns. These, however, pollute the environment to a large degree. As environmental awareness rises, a sustainable way to leave the pattern on products without producing pollutants is demanded, and laser marking seems to be an ideal way to replace inkjet printing and stickers. Nevertheless, since the products usually have 3-dimensional surfaces, there is still a severe problem with traditional laser marking systems. For laser marking, a laser beam should be able to focus on any position where it is expected to leave a mark, which needs to refocus the laser beam again and again when marking on a 3-dimensional surface and slows down the processing speed.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

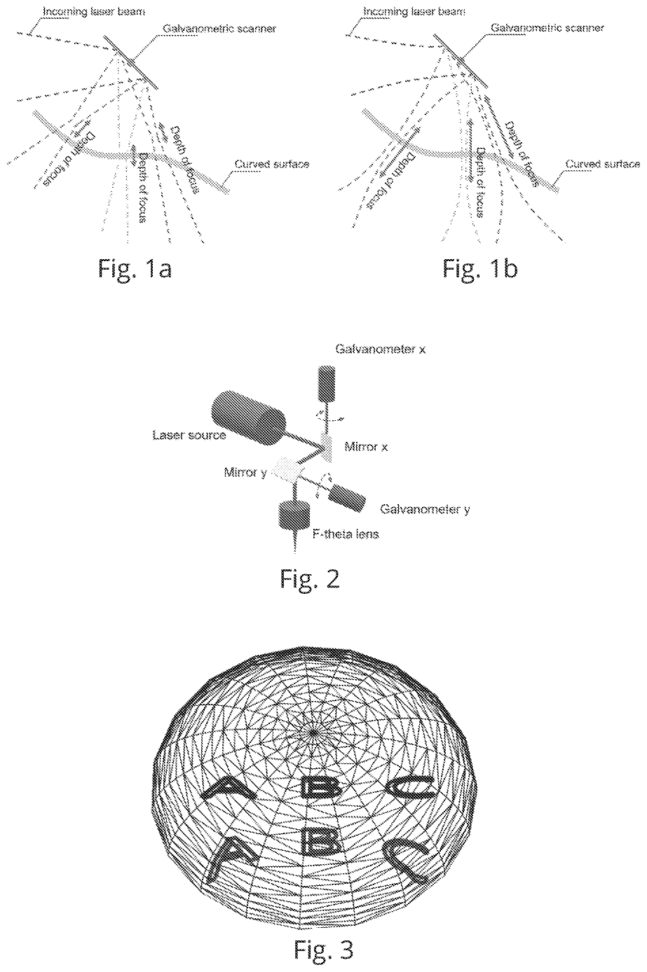

The Applicant has developed a novel optical module to make the depth of focus of a laser beam much longer than a traditional laser beam. It utilizes spherical aberration to transform the incoming laser beam with Gaussian energy distribution into a laser beam with concentric energy distribution. The concentric structure enables a laser beam to stay in focus for a long distance after being converged by a positive lens. FIG. 1 shows how the depth of focus of the laser beam affects the laser marking. The laser beam with a short depth of focus (FIG. 1a) will be out of focus easily, so the energy will be dissipated into a large area, making the energy density too low to leave marks. On the contrary, the laser beam with a long depth of focus (FIG. 1b) can retain its energy density at a much longer distance than the short depth of focus laser beam can, so it can even leave marks on a curved surface. In traditional laser marking systems, the laser beam's depth of focus is usually a few mm, but it can reach 5 cm in the new system, enabling the laser marking system to process a wider range without refocusing the laser beam. With the high-speed laser marking system of the new system, the main drawback i.e., the processing speed, of laser marking compared to inkjet printing and stickers is solved. Yet, a distortion will be inevitably introduced when marking a 2-dimensional pattern onto a 3-dimensional surface. Hence, to accomplish leaving marks on 3-dimensional objects by laser marking, a shape correction method for marking distortion-free patterns onto 3-dimensional objects is needed.

A laser marking system is mainly composed of a laser source, two mirrors that can be rotated perpendicularly with respect to each other by galvanometers, and an f-theta lens that can focus the laser beam on the image plane (FIG. 2).

By giving the x and y coordinates of a 2-dimensional pattern that wants to be marked as the control signal of a galvanometer, the laser beam will be directed to this position on the image plane. FIG. 3 shows how a 2-dimensional pattern (upper ABC letters) gets distorted when marked on a 3-dimensional curved surface (lower ABC letters). Thus, a method to deform the 2-dimensional pattern beforehand to diminish this distortion to get a proper marking on the 3-dimensional surface is necessary.

3D modelling processes such as polygonal modelling, digital sculpting and curve modelling are used to correct distortions when marking a 2D pattern on a 3D target surface. Each modelling process offers different advantages and disadvantages.

In polygonal modelling, points in 3D space, called vertices, are connected by line segments to form a polygon mesh. However, the polygons are planar and can only approximate curved surfaces using many polygons.

Furthermore, in order to project a 2D pattern on a 3D target surface, we first need to create a suitable polygon mesh of the 3D target surface, then we need to parametrize the 3D target surface into the 2D surface of the 2D pattern to identify where the vertices will land in the 2D pattern and finally we need to trace back the 2D pattern into the 3D target surface. For complex surfaces the polygon mesh can be very complex and the parameterization step is time consuming.

Some digital sculpting processes also use a polygon mesh, when used to project a 2D pattern on a 3D target surface they may need a parameterization step as in polygonal modelling, making it time consuming. One difference with polygonal modelling is that digital sculpting can select and focus on sections of the 3D target surface to create a new polygon mesh, inner mesh, which captures finer details of the surface in the selected sections. Again the creation of the inner mesh is time consuming.

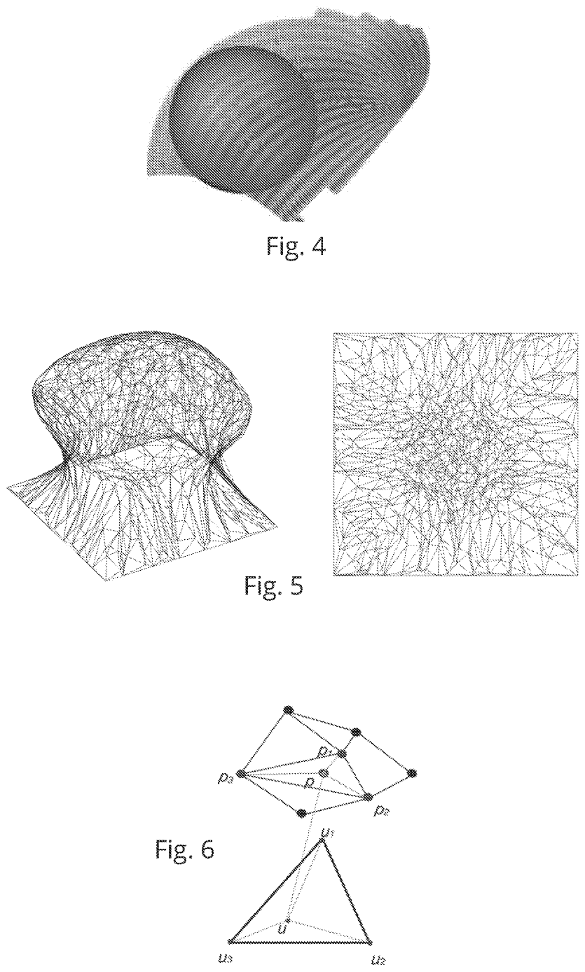

The pre-deformed 2-dimensional pattern for laser marking without distortion can also be obtained by finding a 2-dimensional parameterized plane of the 3-dimensional surface, mapping the 2-dimensional pattern onto this plane, and reversing the 2-dimensional parameterized plane as well as the mapped 2-dimensional pattern back to the original 3-dimensional surface. Then, by removing the original 3-dimensional surface, the mapped pattern without distortion is left, and the laser marking process can be finished by giving the x and y coordinates as the control signal of the laser marking system. The 2-dimensional parameterized plane can be obtained by triangulating the original 3-dimensional surface first, and by following two different criteria: keep the edge-lengths or keep the angles of triangles of the triangulated surface, the triangulated surface can be flattened into a 2-dimensional plane. Because some surfaces, such as spheres, are topologically non-developable, they will lose the accuracy in angle when they are flattened by following the edge-lengths criterion and vice versa. In some cases, the surfaces will be flattened into a plane with a complex shape. FIG. 4 shows the example of a sphere flattened into a complex form. So, the 2-dimensional pattern needs to be pre-processed in order to fit this shape, making the mapping process very complicated. Therefore, there is another way to get a parameterized plane. Based on graph theory, a method to parameterize surfaces into a predefined convex polygon was proposed. In this method, the boundary of the triangulated surface will be mapped into a convex polygon like a unit square or a unit circle. FIG. 5 shows the example of a dome and its parameterization in a plane. Then, the inner vertices of triangles will be determined by solving a linear system based on convex combinations. In this method, the area of the parameterized plane will not be the same as that of the original 3-dimensional surface, so the 2-dimensional pattern still needs to be resized before being mapped onto the parameterized plane. For both methods, the relationship between a 3-dimensional surface and its parameterized plane is a unique affine mapping (FIG. 6):

$$P ( u ) = \frac{A ( {u}_{1} , {u}_{2} , {u}_{3} ) {p}_{1} + A ( {u}_{1} , u , {u}_{3} ) {p}_{2} + A ( u 1 , {u}_{2} , u ) {p}_{3}}{A ( {u}_{1} , {u}_{2} , {u}_{3} ) {p}_{2}}$$

where {p₁, p₂, p₃} are the vertices of a triangle of the 3-dimensional triangulated surface and {u₁, u₂, u₃} are the vertices of its corresponding triangle on the parameterized plane. To map the 2-dimensional pattern onto the 3-dimensional surface, each point of the 2-dimensional pattern should be located in one triangle on the parameterized plane, and the corresponding location on the 3-dimensional surface can be found through affine mapping.

The 2-dimensional pattern needs to be either pre-processed or resized before being mapped, and the process of locating points of the 2-dimensional pattern in the triangles on the parameterized plane is time-consuming. When applying laser marking to the production line, it is desired to mark products as fast as possible to maximise productivity. In other words, a time-consuming pattern mapping method that will slow the speed of a production line down is not suitable for a fast production line. Although it is possible to use a powerful computer to speed up the calculation, the cost will also be dramatically increased since the expense of the powerful computer itself and the energy consumption of operating it can be extremely high. Due to these drawbacks, surface parameterization is not an ideal way for generating pre-deformed 2-dimensional patterns for laser marking, and it can be said that it is still lacking a fast and easy way to generate pre-deformed 2-dimensional patterns.

With a unique optical module, a laser beam is able to maintain its focus entirely over a 3-dimensionally shaped object. Therefore, some companies are interested in employing this novel system in their production line. For example, with the increasing demand for personalised computer hardware, such as mouses and keyboards, laser marking can be used to decorate these products with unique patterns. This system can also be used in labelling the expiry date, barcode, or logo on the products themselves, so the usage of ink and stickers would be reduced. For this application, the objective of this project is to provide an algorithm that can deform the 2-dimensional pattern properly beforehand so that it can be marked onto a 3-dimensional surface without losing its profile. For the personalised printed case, the surface of the object is determined, but for the other cases, e.g. marking on a fruit, the surface of the object needs to be acquired by a shape detection device. Hence, the algorithm proposed in this project should be able to deal with correcting the shape of the 2-dimensional pattern after marking onto both an object with a pre-determined model and an object with an unknown shape.

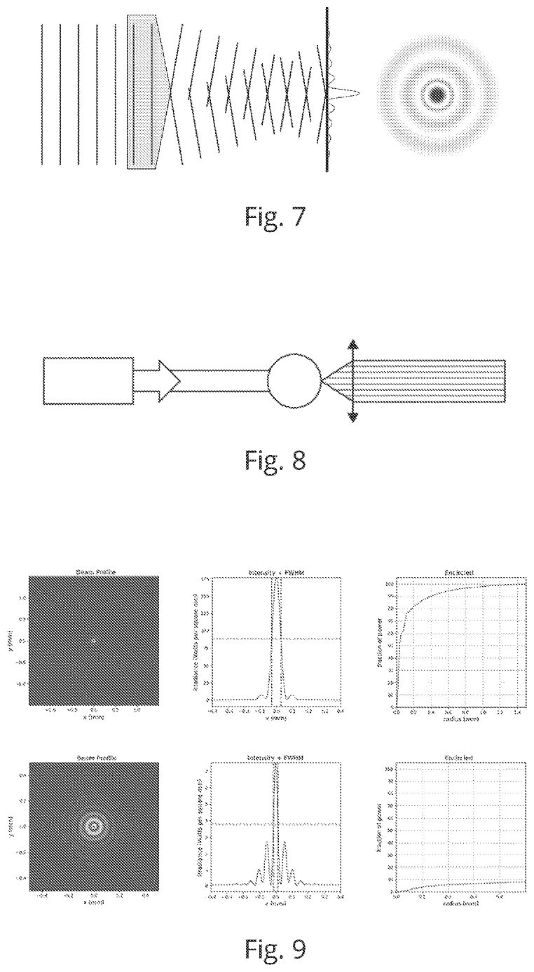

In laser marking, the laser beam should be focused on the point that should be processed to make the material absorb enough energy to induce chemical reaction, charring, melting, or evaporating. A laser beam with a short depth of focus will quickly lose its focus when processing a surface with height variation, making it only applicable to flat surfaces. On the other hand, a laser beam with a long depth of focus and high energy intensity can make the beam spot contain enough energy for a long distance, which allows it to process curved surfaces and make it an ideal source for laser marking. Traditionally, the light beam that comes out from the laser is a Gaussian beam, whose depth of focus is short, and the energy distribution within the beam's spot is a Gaussian distribution, making it far from an ideal source for laser marking. In contrast, the Bessel beam is a type of light beam that has a concentric structure that can be used to make a depth of focus that is much longer than what can be obtained with a Gaussian beam. A Bessel beam can be produced by making a Gaussian beam pass through an axicon lens. (FIG. 7). Because of the conical structure of an axicon, a Gaussian beam with a planar wavefront will be bent in different progressing directions. Then, these bent wavefronts will interact with each other to form a light beam with intensity distribution on the cross-section plane being represented by the Bessel function, which is known as a Bessel beam. When a Bessel beam is converged by a positive lens, the central spot will be focused at the focal point. With the propagation of the beam, this central spot will diverge after the focal point, but the surrounding rings will also converge to form the new central spot, making the long depth of focus of the Bessel beam. There are still some other properties of the Bessel beam to make it supremely qualified for serving as the source for laser marking: non-diffracting, self-healing, low divergence of the central spot, and small size of the central spot.

Theoretically, the central spot of the Bessel beam is surrounded by infinity concentric rings, and the energy within a Bessel beam is evenly distributed into the central spot and these rings. That is to say, the Bessel beam will contain infinite energy, so the ideal Bessel beam can never be generated. Besides that, since only the central spot is used in laser marking, the energy within the rings would be wasted. To solve this problem, several optical systems for producing structured beams (SBs) have been proposed, which share the same properties as Bessel beams (i.e., long depth-of-focus, low divergence, etc.) but don't have infinity concentric rings and most of the energy is in the central spot. When a collimated light beam passes through a convex lens with a high refractive index, the different radial segments of the incoming beam will follow different paths with different phase delays due to the spherical surface of the convex lens, which is also known as spherical aberration. After emerging from the convex lens, the rays with different phases will interfere with each other and form aSB. Because of the high refractive index of the convex lens, the emerging beam would diverge quickly, so putting a focusing lens behind the convex lens is needed to capture the SB. FIG. 8 shows one of the optical systems proposed to generate SBs, the convex lens used in this system is a ball lens, and the focusing lens used in capturing the SB is called an expander lens.

There is still a downside to the proposed technology. The SB that comes out from the ball lens will diverge so rapidly that the expander lens cannot capture all this beam, making a lot of energy not applicable in laser marking. A possible solution is to put the expander lens as close to the ball lens as possible. In this way, an extremely short focal length expander lens might be needed, which has limitations since that kind of lens might be difficult to manufacture. Based on the available SB technology, new SBs were developed, which solve this disadvantage. A spherical mirror or a spherical lens is exploited to induce spherical aberration. In this case, the outgoing beam will not diverge fast as the ball lens system does. Then, by carefully choosing the shape, refractive index, and position of the expander lens, SBs have a longer focus, a larger depth of focus, and a high power ratio within the central spot can be generated. FIG. 9 shows the comparison of beam profile, intensity, and energy ratio encircled within a certain radius. It can be found that the radius of the central spot (distance between the peak of the central spot and the peak of the first ring) of the new SB system is around 0.1 mm (upper graphs of FIG. 9), and the energy ratio encircled within this radius is around 70%. On the contrary, the central spot of previous SB only has less than 10% energy ratio (lower graphs of FIG. 9).

Non-Uniform Rational B-Spline (NURBS) is a way to construct a curve or a surface in 3-dimensional space in computer-aided design software.

In curve modelling, the surfaces are defined by curves, which are influenced by weighted control points. In a more specific example, the curve modelling process of Non Uniform rational B-spline (NURBS) is used to correct projection distortions. NURBS is a mathematical model using basis-spline. Splines are functions defined piecewise by polynomials and basis splines (B-splines) are spline functions that have minimal support with respect to a given degree, smoothness, and domain partition. Any spline function of a given degree can be expressed as a linear combination of B-splines of that degree. B-splines are used for curve-fitting using a series of known points (knots). In a specific case, the knots are equidistant from each other and the relation between the points in a 2D surface and their projection in a 3D surface is given. Compared to other 3D modelling processes, curve modelling does not use a polygon mesh or a parameterization step to identify the relation between points in a 2D pattern and their projection in a 3D target surface.

Depending on the specific application, the geometry of the 3D target surface could be known a priori, as in the case of production lines where cans, boxes, containers or manufacturing parts, to be laser processed, have defined shapes with specific dimensions and tolerance.

It is also possible to laser processed objects with varying shapes. In this case, the shape of the 3D target surface can be captured using an external detection system, such as a camera system, a time of flight sensor, a laser scanner or a LiDAR, among other possibilities. Some examples of objects with varying shapes are fruits, vegetables and free form objects.

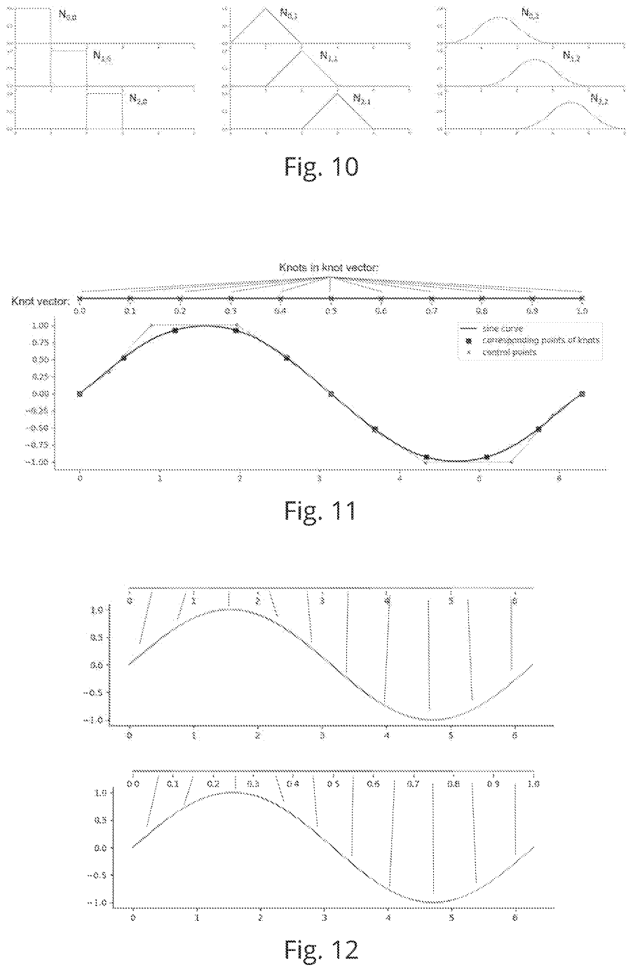

A curve can be regarded as the continuous trajectory of a moving point, so we can only choose some sample points on a curve to represent it in the discrete system. That is to say, the value between two sample points should be determined in other ways. One of these ways is an interpolation. By choosing the proper weight of two adjacent sample points, the value in any position of the curve can be approximated by the adjacent sample points and their weights. In fact, NURBS is also an interpolation method, whose interpolated value consists of a number of polynomials. These polynomials is defined by basis function N_{i,p}(u):

$${N}_{i , 0} ( u ) = \{ \begin{matrix}1 , & {u}_{i} \leq u \leq {u}_{i + 1} \\ 0 , & otherwise\end{matrix}$$

$${N}_{i , p} ( u ) = \frac{u - {u}_{i}}{{u}_{i + p} - u} {N}_{i , p - 1} ( u ) + \frac{{u}_{i + p + 1} - u}{{u}_{i + p + 1} - {u}_{i + 1}} {N}_{i + 1 , p - 1} ( u )$$

where uᵢ is given by knot vector U, i=0, . . . , m with m+1 is the number of knots in U, and p is the order of polynomials used in approximating the curve. In general, a curve will be approximated by second-order p=2 polynomials. FIG. 10 shows the plots of basis functions with order p=0, 1, 2 and knot vector U={0, 1, 2, 3, 4, 5, . . . }, it can be seen that a smooth curve can be approximated with at least second order (p=2) polynomials.

After having the basis function N_{i,p}(u), a NURBS curve can be represented by the equation:

$$C ( u ) = \frac{{\sum }_{i = 0}^{m} {N}_{i , p} ( u ) {w}_{i} {P}_{i}}{{\sum }_{i = 0}^{m} {N}_{i , p} ( u ) {w}_{i}}$$

The value at a specific position on the target curve C(u) can be obtained by summing up the product of all basis function N_{i,p}(u) with knot vector U={u₀, . . . , uᵢ, . . . , uₘ₋₁} and the control points Pᵢ as well as the weight wi and normalised by dividing the summation of product N_{i,p}(u) and wᵢ. FIG. 11 shows a sinusoidal curve constructed by NURBS with given control points and knot vectors.

It is not always that the control points and knot vector are given. More commonly, the curve should be reconstructed by using a set of sample points. In this situation, the knot vector U can be obtained through this approach:

$$U = \{ 0 , 0 , … , 0 , {u}_{p + 1} , … , {u}_{m} , 1 , 1 , … , 1 \}$$

$${u}_{j + p} = \frac{1}{P} {\sum }_{i = j}^{j + p - 1} {\overline{u}}_{i} , for j = 1 , … , m - p$$

where the ūᵢ is obtained by sample points Q={Q₀, . . . , Qⱼ, . . . . Qₘ} through chord length parameterization:

$${\overline{u}}_{0} = 0 , {\overline{u}}_{m} = 1$$

$${\overline{u}}_{i} = {\overline{u}}_{i - 1} + \frac{\vert {Q}_{i} - {Q}_{i - 1} \vert}{{\sum }_{j = 0}^{m} \vert {Q}_{j} - {Q}_{j - 1} \vert} , for i = 1 , … , m$$

Since the interval of the knot vector is determined by the chord length between sample points of the target curve, if line segments with the same length in the knot vector domain are mapped onto the target curve, they will still retain the same length. This is the reason why NURBS can be used in eliminating distortion of pattern mapping. After having the knot vector, the sample points can be treated as the points C(u) and the uᵢ calculated from sample points are the corresponding u for the input to calculate basis function N_{i,p}(u). Then, by giving value to weights wᵢ, the control points Pᵢ can be determined. FIG. 12 shows mapping ten straight line segments of the same length onto a sinusoidal curve by projecting them orthogonally and through NURBS. In FIG. 12 (upper graph), the line segments projected onto the parts with larger curvature of the sinusoidal curve will be elongated more than those projected onto smaller curvature parts. That is to say, each line segment is in different length after mapping. In FIG. 12 (lower graph), the line segments mapped through NURBS will still be the same length because of the chord length parameterization used in creating a knot vector.

### NURBS Surface

The process of constructing a NURBS surface is very similar to that of the NURBS curve. The difference between them is the span created by the knot vector. The value on a curve can be obtained by only considering one parameter, but there are two parameters that should be taken into consideration to determine the value on a surface. Hence, another knot vector should be added to expand the span from a 1-dimensional line to a 2-dimensional plane. For the same reason, two basis functions may be needed to determine the value of certain point S(u, v) on the surface:

$$S ( u , v ) = \frac{{\sum }_{i = 0}^{n} {\sum }_{j = 0}^{m} {N}_{i , p} ( u ) {N}_{j , p} ( u ) {w}_{i , j} {P}_{i , j}}{{\sum }_{i = 0}^{n} {\sum }_{j = 0}^{m} {N}_{i , p} ( u ) {N}_{j , q} ( v ) {w}_{i , j}}$$

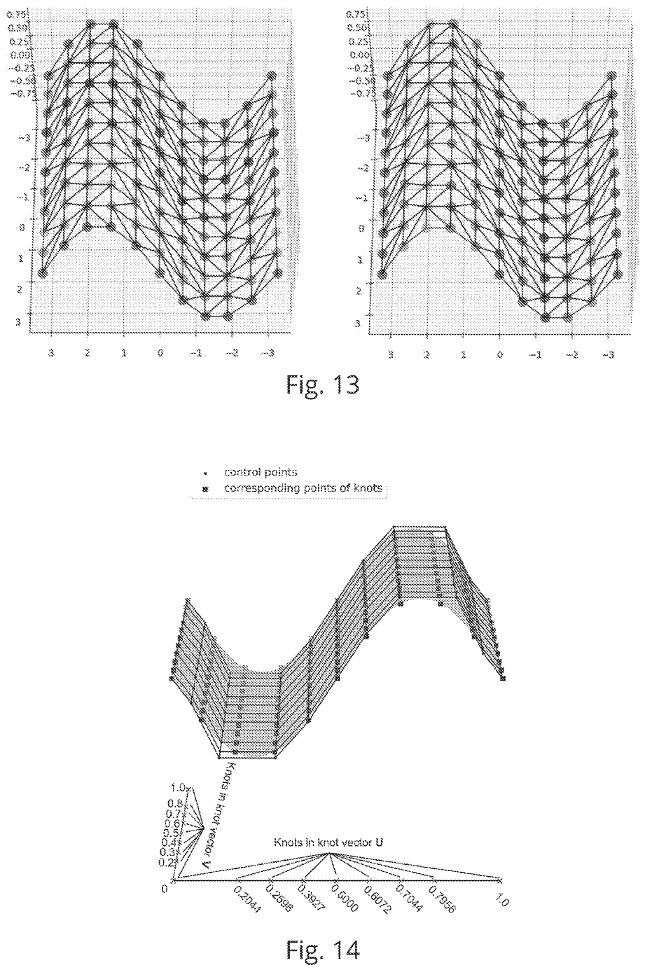

To calculate the knot vectors U and V, the sample points of the target surface Q={Q_{i,j}} for i=0, . . . , m and j=0, . . . , n should be sliced in two different directions along i (FIG. 13, left) and j (FIG. 13, right) respectively. Then, knot vectors U and V are obtained using the corresponding equations. With the same process as reconstructing a NURBS curve, basis functions N_{i,p}(u) and N_{j,q}(v) and by giving value to weights w_{i,j}, the control points P_{i,j} can be determined. Usually, third-order polynomials are used in constructing a NURBS surface. FIG. 14 shows a sinusoidal surface reconstructed through NURBS with 11×11 sample points in i and j direction, knot vectors
U={0, 0, 0, 0, 0.2044, 0.2956, 0.3927, 0.5, 0.6072, 0.7044, 0.7956, 1, 1, 1, 1},
V={0, 0, 0, 0, 0.2, 0.3, 0.4, 0.5, 0.6, 0.7, 0.8, 1, 1, 1, 1}, order p, q=3 and w_{i,j}=1 for all i, j.

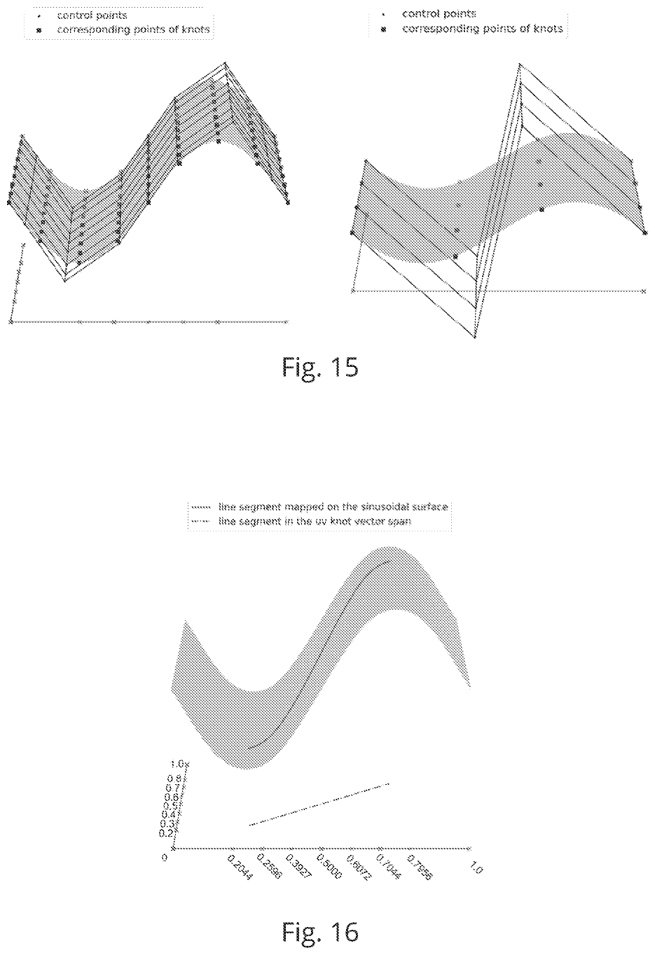

It should be noted that, since NURBS is an interpolation method, the number of sample points will largely affect the reconstructed surface. If the sample points fail to include some features of the original surface, these features will not be shown in the reconstructed surface. FIG. 15 shows sinusoidal surfaces reconstructed through NURBS with a different number of sample points. The sinusoidal surface in FIG. 15 (left) is reconstructed with 9×9 sample points and the sinusoidal surface in FIG. 15 (right) is reconstructed with 4×4 sample points. It is clear that the two peaks of the sinusoidal surface in FIG. 15 (left) are flatter than those of the sinusoidal surface in FIG. 15 (right). It is caused by an insufficient number of sample points. That is to say, the sampling rate is too low so some peak features of a sinusoidal surface might not be sampled and the sinusoidal surface will not be approximated by NURBS properly.

A mapped pattern without distortion means the distance between every pair of selected points of the 2-dimensional pattern will remain the same after being mapped onto a 3-dimensional surface. Thus, a method to calculate the distance between two points on a NURBS surface is needed. Since it is extremely complicated to use the Newton-Leibniz formula in calculating the integral of NURBS, a numerical integration method: Simpson's rule will be adopted to calculate curve length.

Unlike the distance between two points in the points can be easily obtained by calculating the length of the straight line segment connected by these two points, the distance between two points lying on a surface should be calculated by considering the curve connected by these two points on the surface. Imagining there is a bug crawling on a surface from one point to another, then the path of this crawly bug is the curve y and the distance between these two points is the length of this path that can be calculated by Equation:

∫∥\acute{γ}(t)∥dt

Suppose the surface is represented by σ(u, v). Since curve y lies on this surface, it can be written in γ(t)=σ(u(t), v(t)) and the differential form of Y can be written in:

$$\dot{γ} ( t ) = \frac{\partial σ}{\partial u} \frac{du}{dt} + \frac{\partial σ}{\partial v} \frac{dv}{dt}$$

Let

$$\frac{\partial σ}{\partial u} = {σ}_{u} , \frac{\partial σ}{\partial u} = {σ}_{u} ,$$

then the dot product of \acute{γ} and \acute{γ} can be written in:

$$‖ \dot{γ} ( t ) ‖ = \dot{γ} \cdot \dot{γ} = {‖ {σ}_{u} ‖}^{2} + 2 {σ}_{u} \cdot {{σ}_{v} ( \frac{du}{dt} )}^{2} {( \frac{dv}{dt} )}^{2} + {‖ {σ}_{u} ‖}^{2}$$

Let ∥σᵤ∥²=E, σᵤ·σᵥ=Fₜ∥σᵤ∥²=Gₜ, the first fundamental form is given in:
first fundamental form=Edu²+2Fdudv+Gdc²
and the length of curve y in Equation 2.6 can be rewritten in:

$$\dot{u} = \frac{du}{dt} and \dot{v} = \frac{dv}{dt} .$$

Where

$$\int ‖ \dot{γ} ( t ) ‖ dt = \int {( E {\dot{u}}^{2} + 2 F \dot{u} \dot{v} + G {\dot{v}}^{2} )}^{\frac{1}{2}} dt$$

the first fundamental form of the surface, the length of curves lying on it can be calculated.

### Line Integral of NURBS Curve

To apply the first fundamental form to a NURBS curve, the derivative of the NURBS curve should be pointed out first:

$$\begin{matrix}\frac{dC ( u )}{du} = {C ( u )}^{′} \\ = {( \frac{{\sum }_{i = 0}^{m} {N}_{i , p} ( u ) {w}_{i} {P}_{i}}{{\sum }_{i = 0}^{m} {N}_{i , p} ( u ) {w}_{i}} )}^{′} \\ = \frac{{\sum }_{i = 0}^{m} {{N}_{i , p} ( u )}^{′} {w}_{i} {P}_{i} {\sum }_{i = 0}^{m} {N}_{i , p} ( u ) {w}_{i}}{{( {\sum }_{i = 0}^{m} {N}_{i , p} ( u ) {w}_{i} )}^{2}} - \\ \frac{{\sum }_{i = 0}^{m} {N}_{i , p} ( u ) {w}_{i} {P}_{i} {\sum }_{i = 0}^{m} {{N}_{i , p} ( u )}^{′} {w}_{i}}{{( {\sum }_{i = 0}^{m} {N}_{i , p} ( u ) {w}_{i} )}^{2}}\end{matrix}$$

where the term N_{i,p}(u)′ equals to:

$${{N}_{i , p} ( u )}^{′} = \frac{p}{{u}_{i + u} - {u}_{i}} {N}_{i , p - 1} ( u ) - \frac{p}{{u}_{i + n + 1} - {u}_{i + 1}} {N}_{i + 1 , p - 1} ( u )$$

In this case, the crawly bug moves on the NURBS curve C(u) with variable u, so the path length from the start point a to the endpoint b of the bug can be written in:

$${\int }_{a}^{b} ‖ {C ( u )}^{′} ‖ du = {\int }_{a}^{b} {( {Eu}^{′2} + 2 {Fu}^{′} {v}^{′} + {Gv}^{′2} )}^{\frac{1}{2}} du$$

Where

$$E = {‖ {C}_{u} ( u ) ‖}^{2} = {‖ {C ( u )}^{′} ‖}^{2} , F = {C}_{u} ( u ) \cdot {C}_{v} ( u ) = 0 ,$$

$$G = {‖ {C}_{x} ( u ) ‖}^{2} = 0 , {u}^{′} = \frac{du}{dx} = 1 , {v}^{′} = \frac{dv}{dx} = 0 ,$$

a, b∈[0,1]. In fact, this form can be regarded as the integral of the tangent of NURBS curve C(u)′ times the infinity small step du within the interval [a, b] and can be rewritten in:

$${\int }_{a}^{b} {C ( u )}^{′} du$$

### Line Integral of NURBS Surface

For the first fundamental form of the NURBS surface, the partial derivative of two different directions u and v should be calculated respectively:

$$\begin{matrix}\frac{\partial S ( u , v )}{\partial u} = {S}_{u} ( u , v ) \\ = {( \frac{{\sum }_{i = 0}^{n} {\sum }_{j = 0}^{m} {N}_{i , p} ( u ) {N}_{j , q} ( v ) {w}_{i , j} {P}_{i , j}}{{\sum }_{i = 0}^{n} {\sum }_{j = 0}^{m} {N}_{i , p} ( u ) {N}_{j , q} ( v ) {w}_{i , j}} )}_{n} \\ = \frac{{\sum }_{i = 0}^{n} {\sum }_{j = 0}^{m} {{N}_{i , p} ( u )}^{′} {N}_{j , q} ( v ) {w}_{i , j} {P}_{i , j} {\sum }_{i = 0}^{n} {\sum }_{j = 0}^{m} {N}_{i , p} ( u ) {N}_{j , q} ( v ) {w}_{i , j}}{{( {\sum }_{i = 0}^{n} {\sum }_{j = 0}^{m} {N}_{i , p} ( u ) {N}_{j , q} ( v ) {w}_{i , j} )}^{2}} - \\ \frac{{\sum }_{i = 0}^{n} {\sum }_{j = 0}^{m} {N}_{i , p} ( u ) {N}_{j , q} ( v ) {w}_{i , j} {P}_{i , j} {\sum }_{i = 0}^{n} {\sum }_{j = 0}^{m} {{N}_{i , p} ( u )}^{′} {N}_{j , q} ( v ) {w}_{i , j}}{{( {\sum }_{i = 0}^{n} {\sum }_{j = 0}^{m} {N}_{i , p} ( u ) {N}_{j , q} ( v ) {w}_{i , j} )}^{2}}\end{matrix}$$

$$\begin{matrix}\frac{\partial S ( u , v )}{\partial v} = {S}_{v} ( u , v ) \\ = {( \frac{{\sum }_{i = 0}^{n} {\sum }_{j = 0}^{m} {N}_{i , p} ( u ) {N}_{j , q} ( v ) {w}_{i , j} {P}_{i , j}}{{\sum }_{i = 0}^{n} {\sum }_{j = 0}^{m} {N}_{i , p} ( u ) {N}_{j , q} ( v ) {w}_{i , j}} )}_{v} \\ = \frac{{\sum }_{i = 0}^{n} {\sum }_{j = 0}^{m} {N}_{i , p} ( u ) {{N}_{j , q} ( v )}^{′} {w}_{i , j} {P}_{i , j} {\sum }_{i = 0}^{n} {\sum }_{j = 0}^{m} {N}_{i , p} ( u ) {N}_{j , q} ( v ) {w}_{i , j}}{{( {\sum }_{i = 0}^{n} {\sum }_{j = 0}^{m} {N}_{i , p} ( u ) {N}_{j , q} ( v ) {w}_{i , j} )}^{2}} - \\ \frac{{\sum }_{i = 0}^{n} {\sum }_{j = 0}^{m} {N}_{i , p} ( u ) {N}_{j , q} ( v ) {w}_{i , j} {P}_{i , j} {\sum }_{i = 0}^{n} {\sum }_{j = 0}^{m} {N}_{i , p} ( u ) {{N}_{j , q} ( v )}^{′} {w}_{i , j}}{{( {\sum }_{i = 0}^{n} {\sum }_{j = 0}^{m} {N}_{i , p} ( u ) {N}_{j , q} ( v ) {w}_{i , j} )}^{2}}\end{matrix}$$

then the length of the curve lying on this NURBS surface can be written in:

$${\int }_{a}^{b} ‖ \dot{S} ( u , v ) ‖ dt = {\int }_{a}^{b} {( E {\dot{u}}^{2} + 2 F \dot{u} \dot{v} + G {\dot{v}}^{2} )}^{\frac{1}{2}} dt$$

Where

$$E = {‖ {S}_{u} ( u , v ) ‖}^{2} , F = {S}_{u} ( u , v ) \cdot {S}_{v} ( u , v ) ,$$

$$G = {‖ {S}_{v} ( u , v ) ‖}^{2} , \dot{u} = \frac{du}{dt} , and \dot{v} = \frac{dv}{dt} .$$

N_{i,p}(u)′, N_{j,q}(v)′ can be calculated by using the equations of the Line integral of NURBS curve. To find u and v, a line segment s(u(t), v(t)) in knot vectors U, V with start point (uₛₜₐᵣₜ, vₛₜₐᵣₜ) and endpoint (u_{end}, v_{end}) should be taken into account. With the changing of variable t from 0 to 1, u and v are also moved from the start point to the endpoint. That is to say, given a specific t and giving it a small change dt, the u(t) and v(t) in this specific point will also be changed to u (t+dt) and v(t+dt). Then u and v is calculated by

$$\frac{u ( t + dt ) - u ( t )}{t + dt - t} = \frac{du}{dt} and \frac{v ( t + dt ) - v ( t )}{t + dt - t} = \frac{dv}{dt} .$$

And the previous equation can be rewritten in:

$${\int }_{a}^{1} ‖ \dot{S} ( u ( t ) , v ( t ) ) ‖ dt = {\int }_{a}^{1} {( E {\dot{u}}^{2} + 2 F \dot{u} \dot{v} + G {\dot{v}}^{2} )}^{\frac{1}{2}} dt$$

FIG. 16 shows an example of a line segment mapped onto a sinusoidal surface with start point (0.25, 0.25) and endpoint (0.75, 0.75) in U, V knot vectors span. Since it is a straight-line segment, the changing rate ^{⋅}u and ^{⋅}v of u and v with respect to t is a constant and can be obtained by the variation between the start point and endpoint of u, v, and

$$\frac{{u}_{end} - {u}_{start}}{{t}_{end} - {t}_{start}} = \frac{0.75 - 0.25}{1 - 0} = 0.5 and$$

$$\frac{{v}_{end} - {v}_{start}}{{t}_{end} - {t}_{start}} = \frac{0.75 - 0.25}{1 - 0} = 0.5 .$$

Numerical integration: Composite Simpson's rule

When referring to the line length integral of NURBS curve and surface, it is obvious that the denominator is very complicated so the Newton-Leibniz formula can hardly be used in calculating this integration. Hence, the assistance of a numerical integration method may be needed. Simpson's rules are several approximations for definite integrals being used in numerical integration. One of these rules is called Composite Simpson's ⅓ rule, or just called Simpson's rule, given in the equation below and will be used in this research to calculate curve length on NURBS surfaces.

$${\int }_{a}^{b} f ( x ) dx \approx \frac{b - a}{3 n} [ f ( {x}_{0} + 4 {\sum }_{i = 1}^{n / 2} f ( {x}_{2 i - 1} ) + 2 {\sum }_{i = 1}^{n / 2 - 1} f ( {x}_{2 i} ) + f ( {x}_{n} ) ]$$

The error between the actual interaction value and the value approximated by Composite Simp son's rule is

$$- \frac{1}{180} \frac{{( b - a )}^{*}}{{n}^{a}} ( b - a ) {f}^{( 4 )} ( ξ ) ,$$

where ξ is some number between a and b. It is clear that the approximation will be more accurate when n is larger, but it will also be more demanded on computation power.

To apply Composite Simpson's rule to calculate curve length on

NURBS surface, the square root of the first fundamental form should be calculated first and this will serve as the function f(t) in Composite Simpson's rule. Then the definite integral will be taken from a=0 to b=1

### NURBS Surface Reconstruction

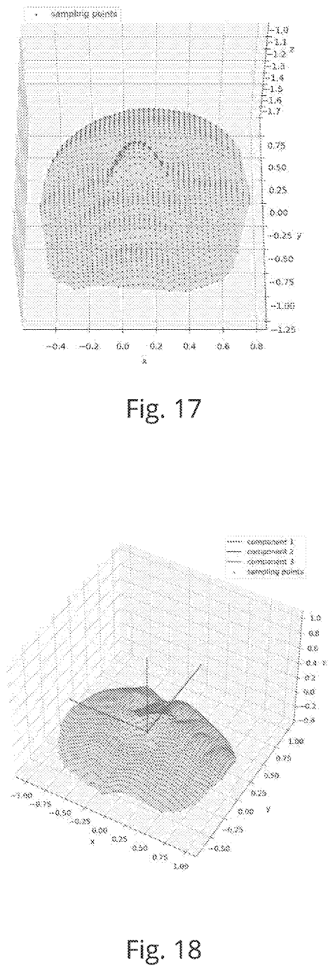

To start reconstructing a NURBS surface, a set of points on the target surface should be sampled first. FIG. 17 shows an example of a target surface.

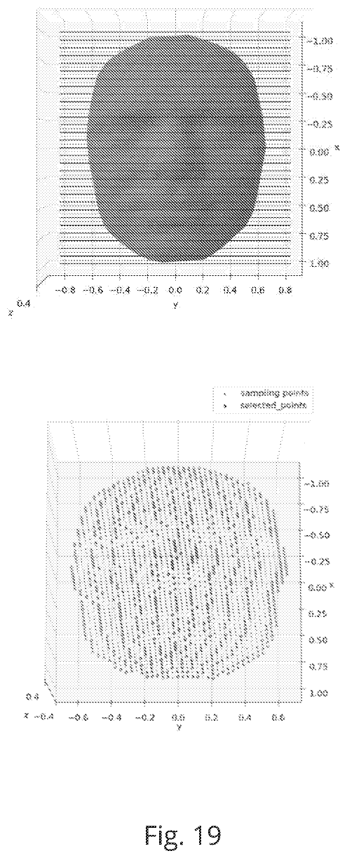

The number of sampling points in each slice should be the same in both u and v directions, but it is not always the case. That is to say, a data selection process should be conducted on the input surface model. In a proposed method for selecting sampling points for reconstructing a NURBS surface, the surface model's position and posture is rearranged by moving the center of mass of the surface model to the origin (0, 0) and aligning the three principal components of the surface model to the x, y, and z axis. Applying this, the rearranged surface can be produced and shown in FIG. 18.

Then, the surface model will be sliced into several slices, and points within the certain slice will be projected onto the central plane of this slice (FIG. 19 upper subfigure). To select the same number of data points in each slice, the maximum number of data points that can be chosen is the number of points of the slice with the least points. The criterion to choose the points in each slice is always choosing the start point and the end point of this slice to make sure the edge will not be lost and the rest of the points should be chosen evenly. FIG. 19, lower subfigure shows the result of the selection.

After having the selected points of the surface model, the NURBS surface can be constructed by finding the chord length parameterization ⁻u and ⁻v in each slice of both u, v directions and knot vectors U and V first. Then, using these selected points as the sampling points of the NURBS surface S(u, v) and ⁻u, ⁻v as the input of basis functions N_{i,p}, N_{j,q}, the control points P_{i,j} can be obtained by: P=SR⁻¹, where R consists of Ri,j, which is called rational function and given in:

$$\frac{{N}_{i , p} ( u ) {N}_{j , q} ( v ) {w}_{i , j}}{{\sum }_{i = 0}^{n} {\sum }_{j = 0}^{m} {N}_{i , p} ( u ) {N}_{j , q} ( v ) {w}_{i , j}}$$

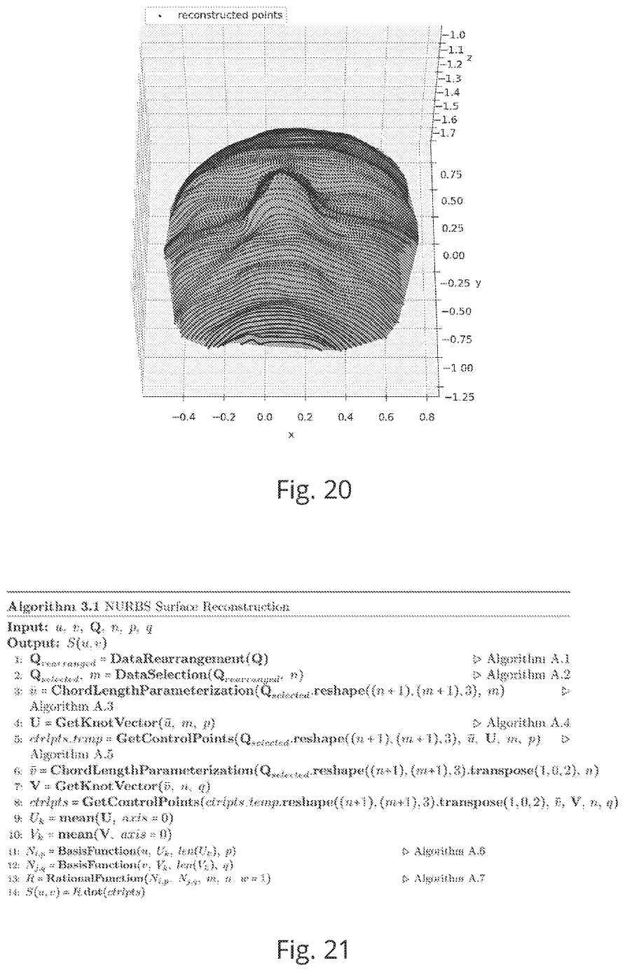

for i=0, . . . , m−1 and j=0, . . . n−1, where m is the number of selected points in slices of u direction and n is the number of selected points in slices of v direction. With the control points P and knot vectors U, V, a NURBS surface is constructed, as shown in FIG. 20, and the corresponding value S(u, v) of each points (u, v) in the knots vectors span can be found. FIG. 21 shows an example of an algorithm 3.1 used to performed the reconstruction.

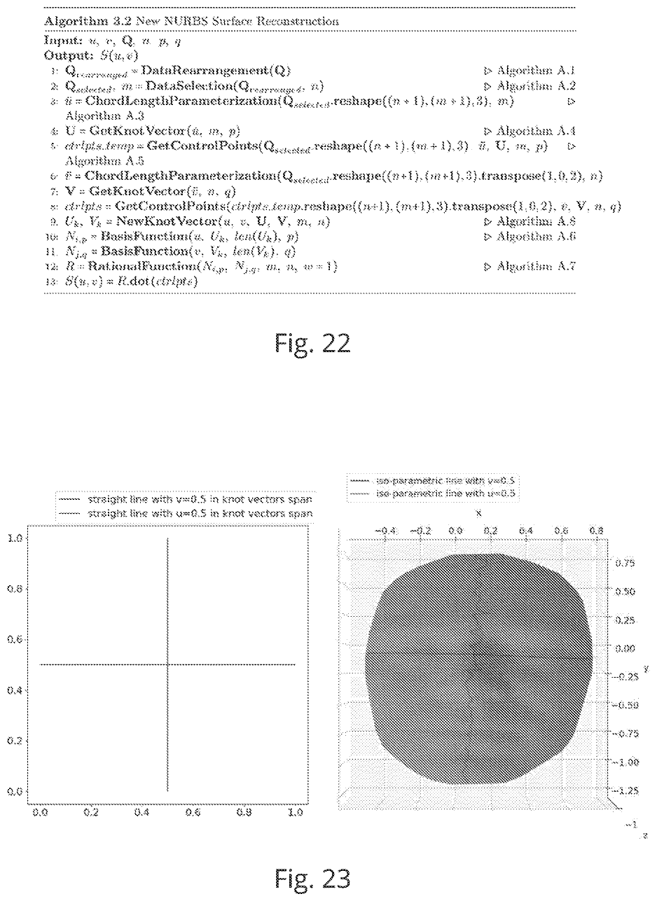

In order to get the selected points for applying NURBS surface, the target surface is divided into several slices, and each slice might have different length based on the geometry of the target surface. That is to say, there are also several different knot vectors will be generated during the process of creating the NURBS surface. In some cases the mean value of corresponding knots in each knot vector is taken as the final knot vector for the input of the NURBS surface reconstruction algorithm. However, this knot vector will have a bad effect on pattern mapping since it can't represent the distance between each knot at all. In this research, a new way to determine the knot vector for the input of the NURBS surface reconstruction algorithm is developed. By finding the point (u, v) that will be reconstructed is located in which two knot vectors, and using the linear interpolation to calculate the final knot vector, this knot vector can still represent the distance between each knot. FIG. 22 shows an example of modified algorithm 3.2.

### Pattern Mapping

By putting the 2-dimensional pattern into the knot vectors span of the reconstructed NURBS surface, this 2-dimensional pattern could be mapped onto the 3-dimensional surface. However, as can be seen in FIG. 19, the selected points are not aligned straightly, and since the control points, which are the main factors to control the positions of reconstructed points, are derived from these selected points, the reconstructed points also will not be aligned straightly. In short, when a straight line in the knot vectors span is mapped onto the NURBS surface, it will no longer be a straight line. FIG. 22 shows two iso-parametric lines (parametric line with one parameter is fixed) u=0.5 (vertical straight line) and v=0.5 (horizontal straight line) that are mapped onto the 3D human face surface model. It is clear that the original surface is sliced along the x axis, so the selected points are aligned in the y direction but not aligned in the x axis. Due to this, the iso-parametric line in the y direction is still aligned straightly but the iso-parametric line in the x direction is distorted. If this NURBS surface is only used in representing the original surface, then this distorted iso-parametric line is not a problem since all the reconstructed points are still on the surface. Nevertheless, when it comes to mapping patterns onto the target surface, the distorted straight line after mapping is not acceptable, and zero padding is applied to solve this problem.

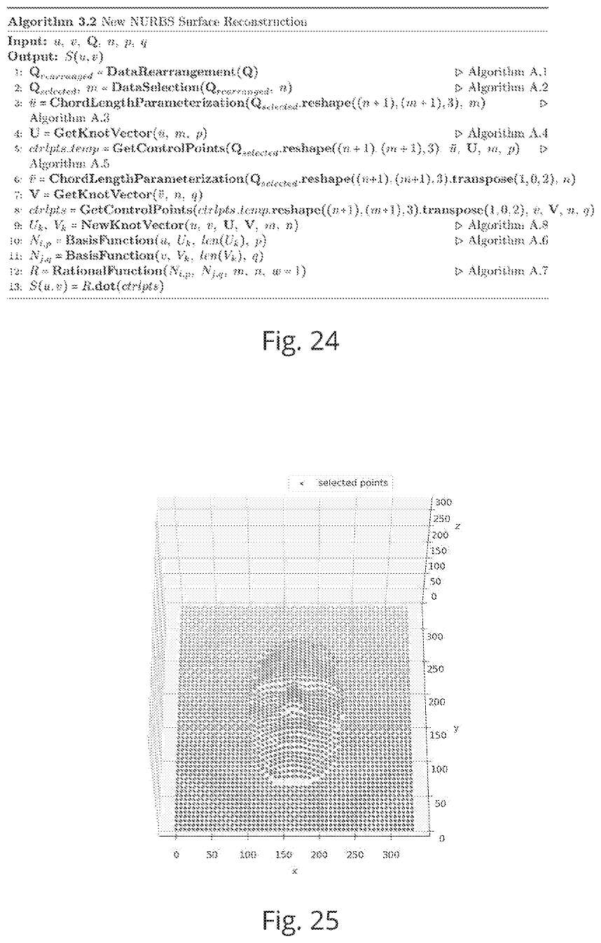

The reason for the distorted iso-parametric line is the different number of sampling points in each slice. To solve this problem, points with zero value that would not affect the geometry can be added to make the number of sampling points in each slice consistent. For convenience, an area with the same size as the scanning area of the laser system will be defined. In this area, the z-value of all points that don't belong to the target 3-dimensional surface model will be set to zero. For the data selection process, the sampling step along u and v directions should be defined. The smaller sampling step means more points will be selected and leading to higher precision. The origin point (0, 0) will be the starting point of this process. By moving one sampling step at a time, choosing the nearest point of the surface model with zero padding as the sampling point at this step, the data selection process can be done by stepping through the whole defined scanning area. FIG. 24 shows an example algorithm for zero padding and FIG. 25 shows the result.

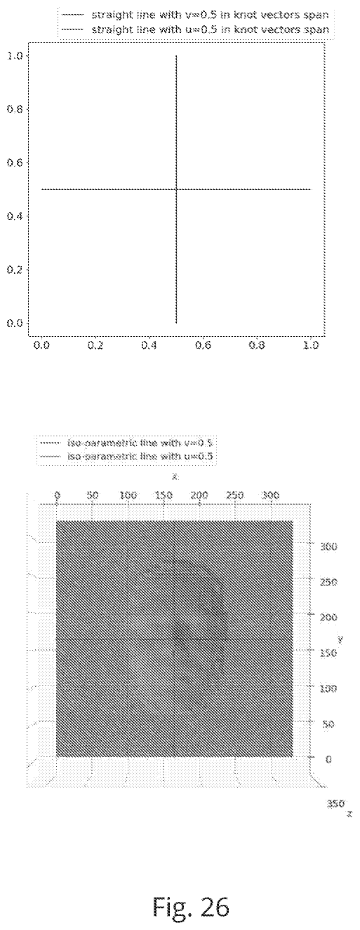

By applying the NURBS surface reconstruction from FIG. 22, this human face NURBS surface can be reconstructed, and since the selected points in each slice of both u and v directions are aligned straightly, the iso-parametric line will not be distorted in this case as shown in FIG. 26 by the horizontal and vertical lines.

After applying zero padding, the 2-dimensional pattern can be mapped onto the 3-dimensional without distortion by directly putting it into the 2-dimensional knots span. Nonetheless, one should keep in mind that the knot vectors originate in chord length parameterization, so if the 2-dimensional pattern is needed to be mapped onto the 3-dimensional surface with a certain size, the size of the 2-dimensional pattern should be scaled to fit the area of the target 3-dimensional surface. There is no intuitive way to scale the 2-dimensional pattern because most 3-dimensional surfaces are with nonzero Gaussian curvatures somewhere, which makes them “doubly curved surfaces”.

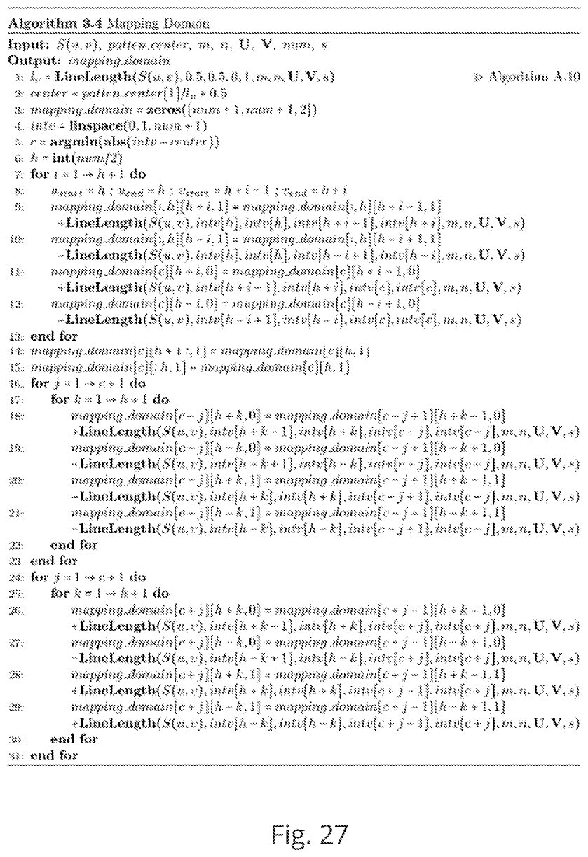

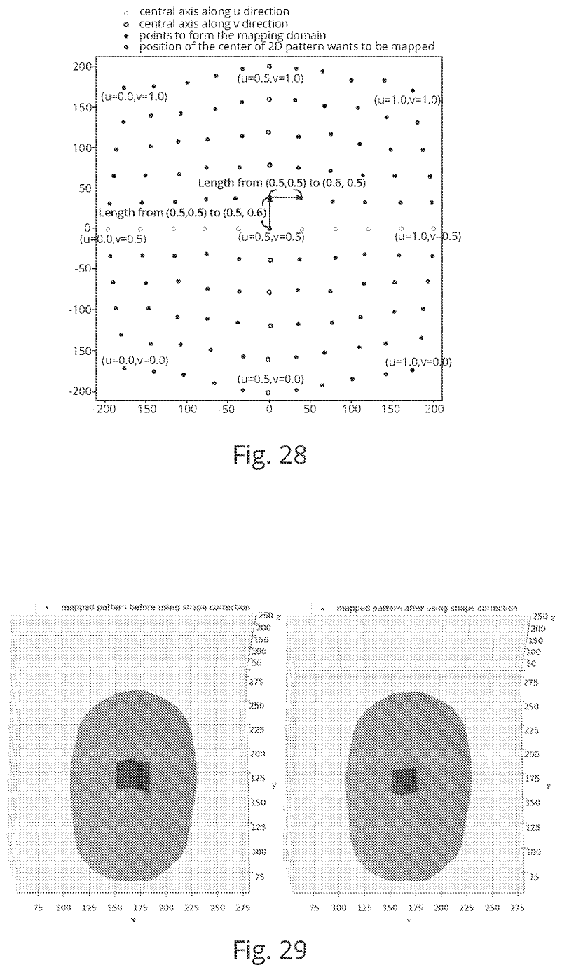

To make sure the distance between two points on the 2-dimensional pattern keeps the same after mapping, some points in the knot vectors span will be chosen evenly, and the distance between these points will be calculated through line integral on NURBS to form a mapping domain. This mapping domain is the area extended (m×n) chosen points and can be created by following continuing steps. First, the knot vector span∈[0, 1] in U and V direction will be evenly divided into n and m parts, and the length of iso-parametric line with u=0.5 will be calculated as lv. Second, the position where the center of 2-dimensional pattern wants to be mapped should be defined, and the distance from the center of the scanning area to the center of 2-dimensional pattern along the v direction will be calculated. By examining the ratio of this distance and lv, the v parameter of the pattern's center can be determined. Then, using the iso-parametric line u=0.5 as the central axis of the mapping domain, values of the mapping domain along n/2 will be given. Still then, finding the nearest point v_{center} to the v parameter of the pattern's center in divided knot vector span V, the iso-parametric line with v=v_{center} will be the other central axis of the mapping domain. Thus, values of the mapping domain along the number index of v_{center}:m_{center}∈[0, m] will also be given. Finally, the rest values of the mapping domain domain(m, n) will be given by calculating the distance between domain(m, n) and domain(m−j, n−i) when m≠m_{center} and n≠n/2, where i=1 if n>n/2 else i=−1 and j=1 if m>m_{center} else j=−1. The mapping area of the 3D human face surface model can be created using an algorithm as the one shown in FIG. 27, giving the result shown in FIG. 28. With this mapping domain, the 2-dimensional pattern can be mapped onto the 3-dimensional surface in the desired size without scaling beforehand.

The distance between two points of the mapping domain is the distance between these two points on the 3-dimensional surface, so the mapping domain is just like the flattened surface. If a 2-dimensional pattern is going to be mapped onto a 3-dimensional surface, it can be easily finished by putting this 2-dimensional pattern into the mapping domain of this 3-dimensional surface and finding the corresponding (u, v) value for applying

NURBS surface reconstruction algorithm. The way to find the (u, v) parameters can be done by locating the point that should be mapped into a quadrilateral formed by four points of the chosen points to create a mapping area first. Then, the (u, v) parameters can be found by applying the inverse bilinear interpolation to the four vertices of this quadrilateral. The inverse bilinear interpolation is given in:

u=u₀₀+(u₀₁−u₀₀)·x+(u₁₀−u₀₀)· [symbol] +(u₀₀−u₀₁+u₁₁−u₁₀)·x·y

v=u₀₀+(u₀₁−u₀₀)·x+(u₁₀−u₀₀)· [symbol] +(u₀₀−u₀₁+u₁₁−u₁₀)·x·y

Where

$$x = \frac{{H}_{i} - {F}_{i} \cdot y}{{E}_{i} - {G}_{i} \cdot y}$$

$$y = \frac{- {k}_{1} \pm \sqrt{{k}_{1}^{2} - 4 \cdot {k}_{0} \cdot {k}_{2}}}{2 \cdot {k}_{2}}$$

There will be two roots for y, the root∈[0, 1] will be chosen, and

H=p(x,y)−p₀₀(x,y)

E=p₀₁(x,y)−p₀₀(x,y)

F=p₁₀(x,y)−p₀₀(x,y)

G=p₀₀(x,y)−p₀₁(x,y)+p₁₁(x,y)−p₁₀(x,y)

k₂=Gᵢ·Fⱼ−Gj·Fᵢ

k₁=Eᵢ·Fⱼ−Eⱼ·Fᵢ+Hᵢ·Gⱼ−Hⱼ·Gᵢ

k₀=Hᵢ·Eⱼ−Hⱼ·Eᵢ

By calculating (u, v) parameters of all points in the 2-dimensional pattern, it can be mapped onto the 3-dimensional surface through putting all (u, v) parameters in the NURBS surface reconstruction, and this process is the shape correction for mapping 2-dimensional pattern onto the 3-dimensional surface without distortion. FIG. 29 shows a square with side length 30 that is being mapped onto the 3D human face surface model before and after using shape correction.

2-dimensional patterns should be able to be marked onto 3-dimensional surfaces with both given CAD models and unknown shapes. If the target surface is given by the CAD model, then it can be used in the shape correction directly. On the other hand, if the target surface's model is not provided, a shape-detecting sensor should be used to obtain the surface model.

For a shape detecting system there are three main non-contact ways to acquire the shape of an object: Time of flight (TOF) sensor, Laser scanner and LiDAR

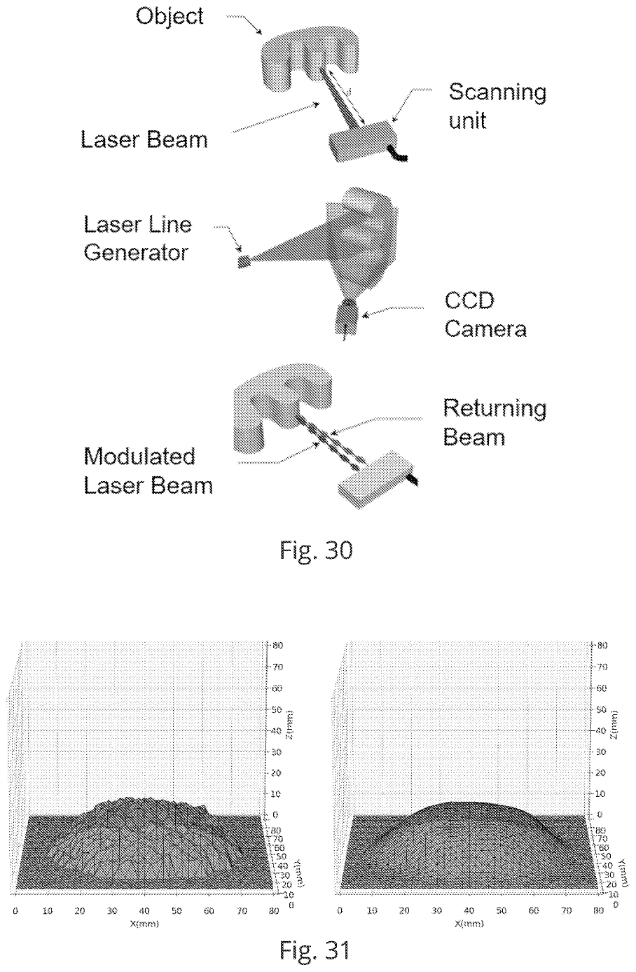

The time of flight sensor (FIG. 30 upper image) measures the time-consuming of a photon travelling from the sensor and reflected by the target object and then back to the sensor. Since the speed of light is a known value, the distance between the sensor and the target can be gotten by multiplying half of the time-consuming and the speed of light.

The laser scanner (FIG. 30 center) projects a line laser onto the target object and uses a camera to record the deformation of this line laser caused by the geometry of the target object. By observing the triangulation relationship between the laser generator, the target object, and the image taken by the camera, the shape of the target object can be derived.

By emitting a modulated laser beam to the target object and comparing it with the returning beam, LiDAR (FIG. 30 lower image) can acquire the shape of the target object. There is a phase shift between the emitted laser beam and the returning beam, which is caused by the distance travelled by the modulated laser beam. Because the wave number of a modulated laser beam is a constant with a known value, the distance travelled by this beam can be calculated by the phase shift.

Each of these methods has its own pros and cons. The ToF sensor is easy to implement and is not affected much by the ambient light, but its accuracy is relatively low compared with the other two methods; for the laser scanner, the advantage of it is its high resolution and accuracy, but the result will be deteriorated by the effect of the ambient light and the processing time is much longer than the other two methods due to the high resolution; the accuracy of LiDAR is also high and it is also not affected much by the ambient light much, but the phase wrapping is always the issue when using phase shift to examine the distance. Besides that, to use the triangulation relationship to acquire the shape of the target object, the laser line generator/camera will also be put at an angle. This angle prevents some regions of the target object to be illuminated/recorded. Still, the working distance of LiDAR is usually much longer than the other two methods, which increases the size of the whole shape-detecting system, making it not suitable for implementation in the production line. Consequently, the ToF sensor will be used in the following example to obtain the surface information of unknown-shape objects.

When using this system, the target object will be put on the lifting platform to ensure the whole object is in the sensor's measurement range. The detection result will inevitably contain some noise. Thus, a low-pass filter will be implemented to remove the noise. FIG. 31 shows the detected result of a mandarin's surface. To eliminate the noise (the zigzags in FIG. 31 left), the frequency of the zigzags needs to be observed first. The width of the zigzags is around 8 mm in this case, and each zigzag can be regarded as half a triangle wave, so the frequency of the noise is 1/16=0.0625/mm. The points of this mandarin surface are sampled every 2 mm, leading the sampling rate to be 0.5/mm and Nyquist frequency will be 0.25/mm, which is four times that of the noise. Hence, a low-pass filter with a cut-off frequency equal to a quarter of the Nyquist frequency is applied to the detected mandarin surface and the filtered result is shown in FIG. 31 right.

### Laser Marking System

An example of a laser marking system consists of a laser source, two mirrors attached to two galvanometers with perpendicular rotation axis to each other, and the f-theta lens that can focus the laser beam onto the target surface. Furthermore, it comprises an optical module that allows the outgoing laser beam to have a long depth of focus. The lifting platform is used for adjusting the distance between the galvanometric scanner and the target object. Air suction is used in removing the gas generated during the marking.

When using this laser system, the target object will be placed onto the lifting platform, so the distance between the galvanometric scanner and the target object can be adjusted to the focus range of the laser beam. In the best case, top of the target object will be at the distance equal to the lower limit of the working range from the galvanometric scanner, so the whole working range is possible to be exploited. Then, the 2-dimensional pattern will be processed by the shape correction method, stored in a vector type file such as dxf file, and imported into the control software of the laser marking system. The vector type 2-dimensional corrected pattern will be the signal to control the galvanometers.

In the traditional laser marking system, the laser beam usually has a few mm depth of focus, so the laser beam will quickly lose its focus when moving along a curved surface directed by the galvanometric scanner. Hence, either a device to change the focal length of the laser beam or a device to change the distance between the target object and the laser source in real time is needed, and both of these devices will increase the complexity of the whole system. However, the laser beam originating from the Applicant's optical module has a 50 mm depth of focus. It means when the thickness of the target surface is less than this value, the laser marking process can be easily finished by directly moving the laser spot to the position information provided by the 2-dimensional pattern.

In an example, a picture file will be the 2-dimensional pattern for laser marking. A mouse model will be the target surface with a given CAD model and a mandarin fruit will be the target surface with an unknown shape. If the pattern is mapped through an orthogonal projection, it will be elongated in the position with large curvature. On the contrary, the corrected pattern will keep its shape even after being mapped onto the large curvature position.

In the following example, the 2-dimensional pattern will be marked onto a mouse and a mandarin using a laser marking system with a long depth of focus.

To evaluate the performance of the shape correction method, the similarity of a 2-dimensional pattern before and after being mapped should be considered. In this example, the perimeter and the area enclosed by this perimeter of the 2-dimensional pattern will be the criterion. To be specific, the contour of the 2-dimensional pattern is composed of many little line segments and the pattern itself consists of little pixels. By summing up the square root of the square of the length difference between each line segment before and after being mapped, the total length error elin perimeter can be obtained:

$$length difference = {l}_{3 d \_ s} - {l}_{2 d \_ s}$$

$${e}_{l} = {\sum }_{s = 0}^{n} \vert {l}_{3 d \_ s} - {l}_{2 d \_ s} \vert$$

where n is the total number of the line segments, l_{2d_s} is the s^{th} line segment before being mapped, and l_{3d_s} is the s^{th} line segment after being mapped. Also, the total area error ea can be obtained by summing up the square root of the square of the area difference between each pixel before and after being mapped:

$$area difference = {a}_{3 d \_ s} - {a}_{2 d \_ s}$$

$${e}_{a} = {\sum }_{s = 0}^{n} \vert {a}_{3 d \_ s} - {a}_{2 d \_ s} \vert$$

where n is the total number of the pixels enclosed by the perimeter, a_{2d_s} is the s^{th} pixel before being mapped, and l_{3d_s} is the s^{th} pixel after being mapped. It is obvious that when el and ea are low, the similarity between the pattern before and after being mapped is high, which also means the good performance of the shape correction method.

Marking on the object with given well-designed surface model.

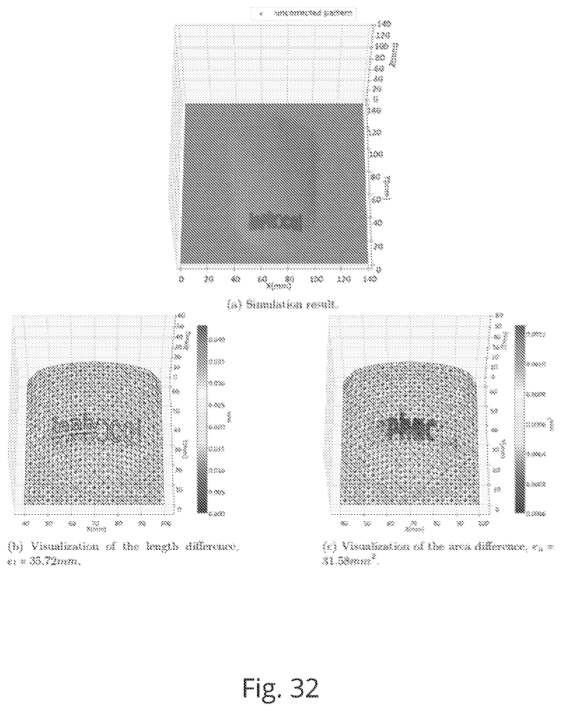

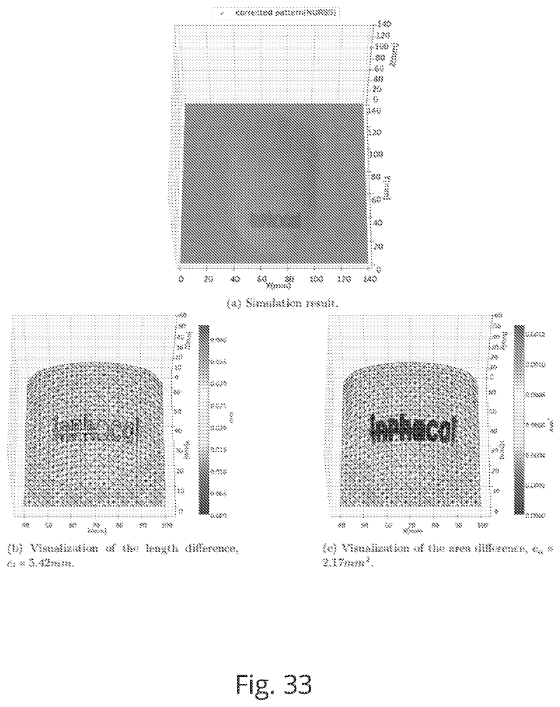

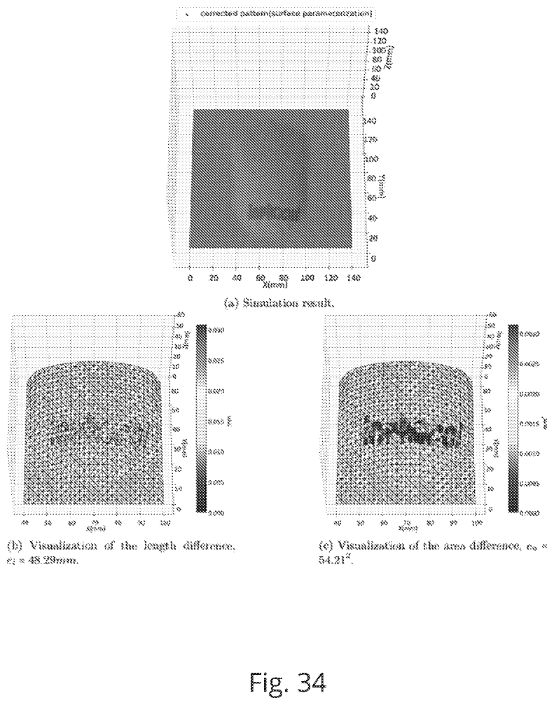

FIG. 32 shows the simulation and evaluation result of mapping an uncorrected pattern onto a mouse's surface. The original 2-dimensional pattern is a picture file of a logo with 1200 pixel×200 pixel. This pattern is scaled in 39 mm×13 mm and orthogonally projected onto the target surface and it will be elongated at the parts of the target surface with large curvature naturally. The original perimeter and area enclosed by this perimeter of this pattern are 318.14 mm and 165.69 mm2. After being projected, the perimeter and the area will be increased to 353.86 mm and 197.27 mm2, and the total length error eₗ is 35.72 mm and the total area error eₐ is 31.58 mm2.

In FIG. 33, the pattern is corrected by the shape correction method through NURBS, which uses 30 points×30 points to create the mapping domain and 50 subintervals in Simpson's rule to calculate distance between those points, and mapped into 39 mm×13 mm. This process costs 74.55 seconds. It can be found that the distortion has been largely eliminated, especially in the left bottom corner and the right bottom corner of the mapped pattern. Through the evaluation method, the decreasing of e (from 35.72 mm to 5.42 mm) and eₐ (from 31.58 mm2 to 2.17 mm2) can also be observed. The perimeter and the area of the mapped pattern are 321.42 mm and 166.82 mm2

FIG. 34 shows the simulation result of mapping the corrected pattern created by surface parameterization onto the mouse's surface. The surface is parameterized into a unit square, so it is hard to scale the pattern into desired size. In this case, the pattern is simply scaled in 1/39 mm× 1/13 mm and put into the parameterized plane for mapping on the target surface. One can easily imagine that the dimensions in the x and y directions of the mouse are different, so the ratio of the mapped pattern will not keep the same. The size and the posture of the mapped pattern might be slightly different as well. Although both the el (from 35.72 mm to 48.29 mm) and the eₐ (from 31.58 mm2 to 54.21 mm2) are increased (due to the size-changing) comparing to that of uncorrected pattern, the elongation at the left bottom corner and the right bottom corner are still eliminated. The whole process takes 1273.23 seconds, and the perimeter and the area of the mapped pattern are 335.74 mm and 218.11 mm2

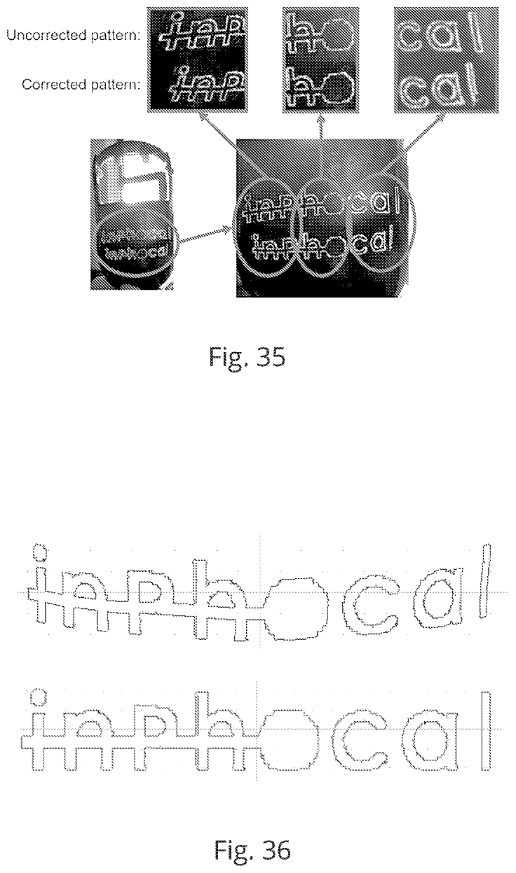

FIG. 35 is the actual marking result of the simulation shown in FIG. 33. The corrected pattern for being imported into the laser marking software is obtained by extracting the x and y coordinates of the mapped pattern. FIG. 36 shows the corrected pattern (upper) and the uncorrected pattern (lower). Since the marking process can be done without changing the distance between the laser source and the target surface through the laser marking system with long focal depth, the z coordinate of the mapped pattern does not need to be recorded and exploited.

Marking on the object with an unknown shape surface model.

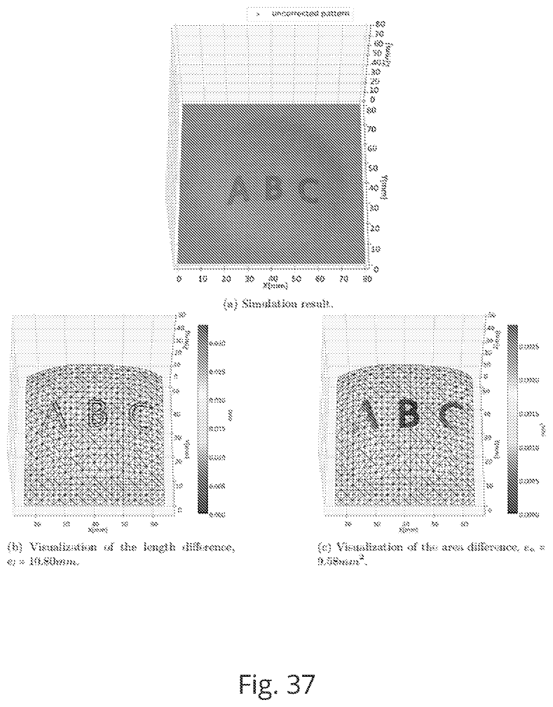

FIG. 37 shows the simulation and evaluation result of mapping an uncorrected pattern onto the mandarin's surface. The original 2-dimensional pattern is a picture file of a string with 572 pixel×192 pixel. This pattern is scaled in 39 mm×13 mm and orthogonally projected onto the target surface and again, it will be elongated at the parts of the target surface with large curvature. The original perimeter and area enclosed by this perimeter of this pattern are 150.58 mm and 81.33 mm2. After being projected, the perimeter and the area will be increased to 161.38 mm and 81.33 mm2, and the total length error eₗ is 10.80 mm and the total area error eₐ is 9.58 mm2.

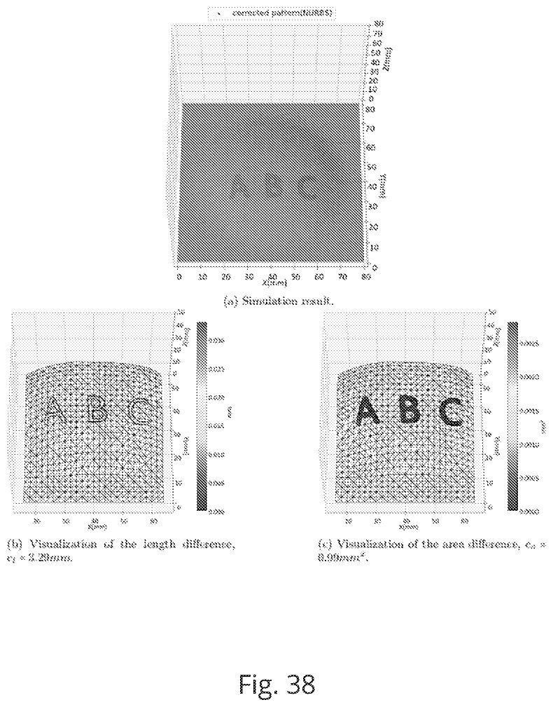

In FIG. 38, the pattern is corrected by the shape correction method through NURBS, which uses 30 points×30 points to create the mapping domain and 50 subintervals in Simpson's rule to calculate distance between those points, and mapped into 39 mm×13 mm. This process costs 48.13 seconds. Compared to the mapped uncorrected pattern, the distortion, especially in the left and the right bottom part, is eliminated. Through the evaluation method, the decreasing of el (from 10.80 mm to 3.29 mm) and ea (from 9.58 mm2 to 0.99 mm2) can also be observed. The perimeter and the area of the mapped pattern are 152.53 mm and 81.66 mm2.

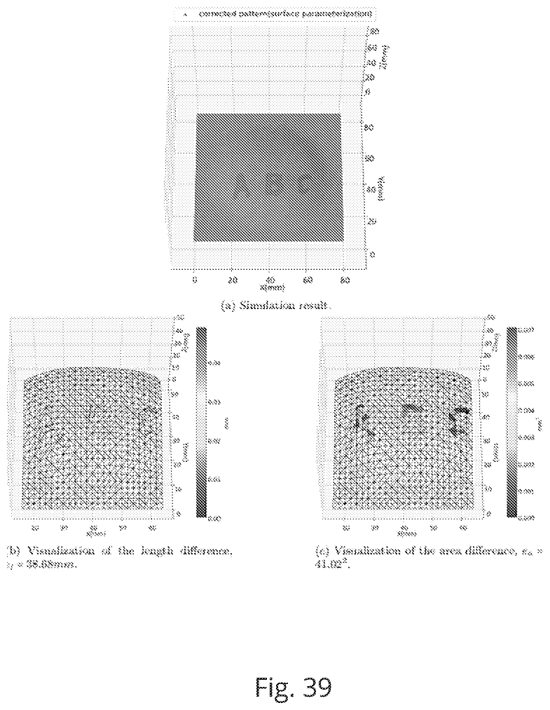

FIG. 39 shows the simulation result of mapping the corrected pattern created by surface parameterization onto the mandarin's surface. The pattern is scaled into 1/39 mm× 1/13 mm and put into the parameterized plane for mapping. Due to the size-changing mentioned before, the el is increased from 10.80 mm to 38.68 mm and the eₐ is in creased from 9.58 mm2 to 41.02 mm2 when comparing to the that of uncorrected pattern. However, the elongation at the left bottom and the right bottom parts is still diminished. The whole process takes 135.23 seconds, and the perimeter and the area of the mapped pattern are 178.75 mm and 118.48 mm2

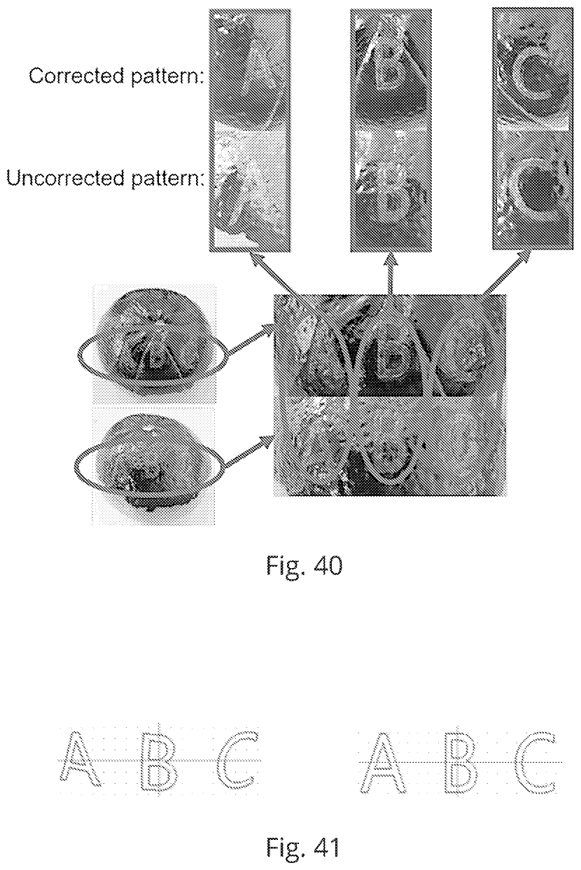

FIG. 40 is the actual marking result of the simulation shown in FIG. 38. The corrected pattern for being imported into the laser marking software is obtained by extracting the x and y coordinates of the mapped pattern. FIG. 41 shows the corrected pattern (left) and the uncorrected pattern (right).

In the previous example, the corrected patterns are created through the shape correction method based on NURBS by using 30 points×points to create the mapping domain and 50 subintervals in Simpson's rule to calculate distance between those points. It is straightforward that both the mapping domains and the integral value can be created as precisely as possible when using a large number of points and subintervals, but it will also increase the computational load. Therefore, a trade-off has to be made between the time cost and the accuracy.

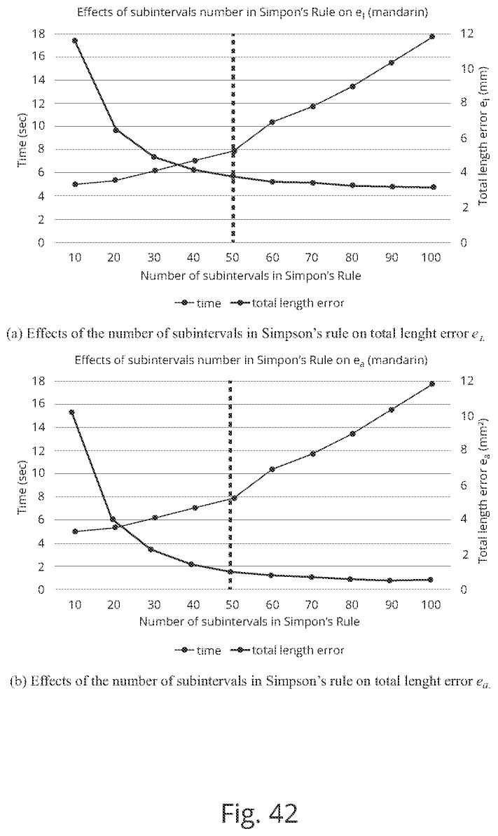

To find the effects of the number of subintervals in Simspon's Rule on correction error, different numbers of subintervals will be chosen to apply Simspon's Rule. Then, in each case, the total length error eₗ and the total area error eₐ will be calculated. FIG. 42 shows the run chart of the number of subintervals versus the cost time and versus the shape correction error. It can be found that if the number of subintervals is more than 50, both the total length error el and the total area error eₐ are not decreasing much when the cost time is significantly increased. Therefore, unless the precision of shape correction is highly demanded, using 50 subintervals in Simspon's rule can give a good corrected pattern with acceptable time consumption.

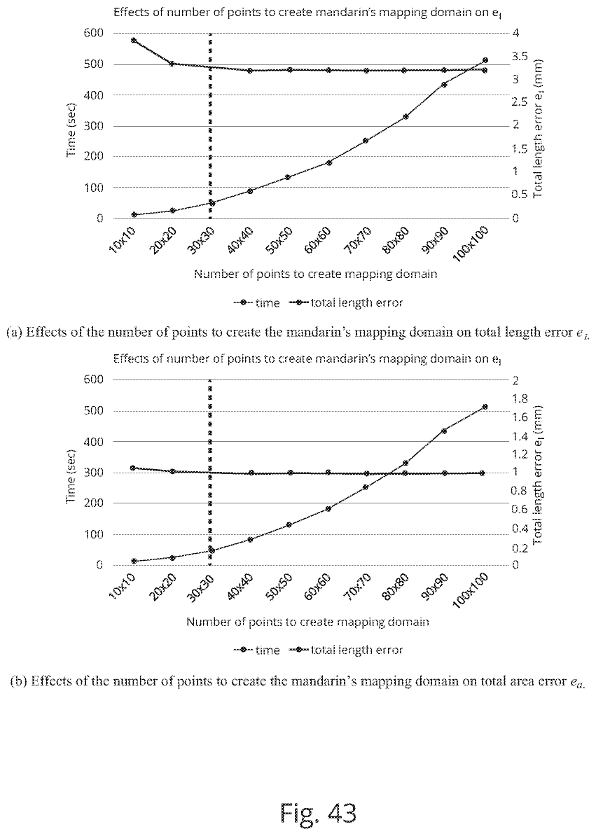

In FIG. 43, different numbers of points are chosen to create the mandarin's mapping domain. It can be seen that the total length error er is decreasing when the number of points is increasing between 10×10 and 30×30. After the number of points is more than 30×30, the total length error el does not change a lot. In the area length error eₐ, there is a slight decrease when the number of points increases from 10×10 to 30×30, but after increasing to more than 30×30 points, the variation can not be observed anymore.

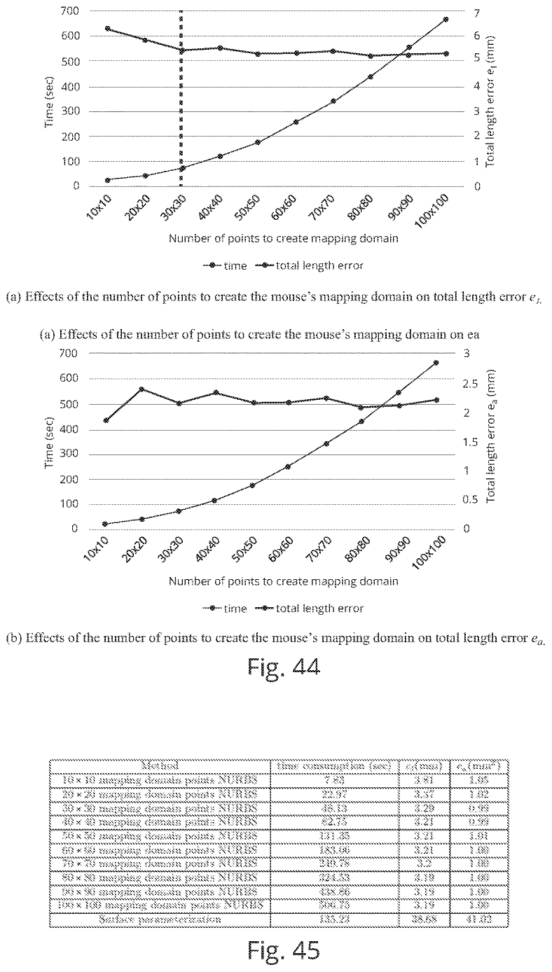

In FIG. 44, different numbers of points are chosen to create the mouse's mapping domain. The effect of the number of points on the total length error el, in this case, is very similar to that of the mandarin case. The decrease of el is obvious when the number of points is less than 30×30, but it becomes unapparent when the number of points is more than 30×30. For the area length error eₐ, the values fluctuate when the number of points is increasing, but the variation is less than 1 mm², which is a low value compared to the total mapped area (165.69 mm²).

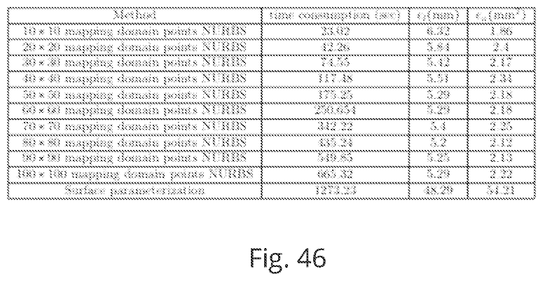

FIGS. 45 and 46 show to Tables with the time consumption, total length difference eₗ and total area error eₐ by using the NURBS-based shape correction method with 50 subintervals and different numbers of points in the mapping domain, and by using the surface parameterization-based shape correction method.

In FIG. 45, the pattern is a picture file of a string with 572 pixel×192 pixel, and in FIG. 46, the pattern is a picture file of a logo with 1200 pixel×200 pixel. Both patterns are scaled in 39 mm×13 mm, and mapped onto the mandarin's surface and the mouse's surface respectively. In both cases, the eₗ and eₐ by using the NURBS-based shape correction method are much lower than that of the surface parameterization-based shape correction method. In the mandarin case, when using less than 50×50 points in the mapping domain by using the NURBS method, the time consumption can also be lower than that of the surface parameterization method. However, in the mouse case, even using 100×100 points in the mapping domain, the time consumption is still lower than that of using the surface parameterization method. It is because there are more points (1200 pixel×200 pixel) that need to be mapped in the logo than the string pattern (572 pixel×192 pixel) used in the mandarin case and the pattern mapping process takes a lot of time in the surface parameterization method. Hence, the advantage in efficiency of the NURBS-based shape correction method can be magnified when mapping patterns with high resolution.

By using the long depth of focus laser marking system, fast laser marking on 3-dimensional surfaces is possible. Through the help of the shape correction method, the patterns will not be distorted after being marked onto the 3-dimensional surfaces. Therefore, the dominant way to print information onto products in the production line, ink and stickers, which pollute our planet severely, can now be replaced by laser marking.

When marking the products with simple shapes such as cans (cylindrical surfaces), shape correction can be done by examining and eliminating the distortion of projected patterns, but the products do not always have such a simple shape. Hence, a more powerful shape correction method is needed to correct patterns for free-form surfaces. The new shape correction method proposed in this research gives a fast and precise way to map 2-dimensional patterns onto 3-dimensional surfaces. Compared to the existing shape correction method based on surface parameterization, this new shape correction method based on NURBS exempts the pre-processing of the 2-dimensional patterns and the time-consuming pattern mapping process. Since products sometimes are not all in the same shape (e.g. fruits), pre-processing the patterns case-by-case may be needed when applying the surface parameterization-based method, and it also costs a lot of time. Such a time-consuming method will slow down the speed of production, so it is more efficient to use this NURBS-based shape correction method, especially when marking high-resolution patterns onto surfaces with complicated shapes.

In the production line, if the products all have the same shapes, the corrected pattern can be generated by the shape correction method beforehand. However, when the products are not in the same shape, the surface information needs to be captured by a shape-detecting system. Then, the unique corrected pattern will be generated for each product. In this case, the shape-detecting system can be placed before the laser marking system at a certain distance, so when it is marking one product, another product can be detected at the same time. This distance can be calculated by multiplying the speed of the production line by the time to complete shape correction. For example, when a string pattern wants to be mapped onto mandarins as the case in section 5.2, it will take around 50 sec to finish the shape correction process. If the speed of the production line is 10 cm/second, the shape-detecting system should be placed 5 m before the laser marking system, so when the mandarin arrives at the place of the laser marking system, the corrected pattern has just been generated.

To apply NURBS, the target surface should be sliced into several slices and the number of sample points in each slice should be the same. In the examples above, zero padding is used to make sure the same number of sample points are in these slices, but it will add additional points in the surface model, increasing the calculation time. In other examples this step can be done with a different method eliminating this constrain.

In the previous example, all patterns are marked on the surfaces by pointwise laser marking, but there is another way to leave patterns by projecting a laser beam onto the target surfaces, which is known as laser lithography. In this method, a plate with holes that form the pattern that wants to be marked, which is also known as a mask, is placed between the laser source and the target surface. When the mask is illuminated by a laser beam, the beam can only pass through the holes, so a visible mark can be left on the target surface. The corrected pattern created by the shape correction method can also be used in producing the mask for distortion-free laser lithography.

For the purpose of clarity and a concise description, features are described herein as part of the same or separate embodiments, however, it will be appreciated that the scope of the invention may include embodiments having combinations of all or some of the features described. Of course, it is to be appreciated that any one of the above embodiments or processes may be combined with one or more other embodiments or processes to provide even further improvements in finding and matching designs and advantages. It is appreciated that this disclosure offers particular advantages to laser marking, and in general can be applied for any application wherein a beam of light is used for processing a curved surface.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise.

1. A laser marking system for marking a curved surface, the system comprising an optical assembly configured to project a laser beam onto the curved surface for applying the marking,
wherein the optical assembly comprises beam steering optics configured to determine a variable position at which the projected laser beam intersects the curved surface;
a beam controller configured to control the beam steering optics based on a control algorithm;
wherein the control algorithm is configured to
receive an input image comprising a set of two-dimensional input coordinates representing nodes of the marking as it is intended to appear on the curved surface,
receive a curvature map representing a three-dimensional curvature of the curved surface,
calculate a set of two-dimensional output coordinates based on the set of two-dimensional input coordinates and the curvature map, wherein, the set of two-dimensional output coordinates is adapted with respect to the set of input coordinates to compensate for a distortion of relative distances between the nodes in the projecting of the laser beam onto the curved surface, and
control the position of the laser beam based on the set of the two-dimensional output coordinates.

2. The system according to claim 1, wherein a pair output coordinates in the set of output coordinates is calculated by
determining, in the set of input coordinates, a pair of input coordinates corresponding to a pair of nodes which are closest neighbors in the input image;
determining, based on the pair of input coordinates, a Euclidian length of a straight line segment along a flat plane of the input image between the pair of nodes;
determining a pair of projected coordinates based on a calculated projection of the pair of input coordinates onto the curvature map in accordance with the projection of the laser beam by the optical assembly via the beam steering optics onto the curved surface;
determining a geodesic length of a curved line segment between the pair of projected coordinates along a manifold of the curvature map, and
adapting the pair of output coordinates with respect to the pair input coordinates to minimize a difference between the geodesic length of the curved line segment along the manifold of the curvature map relative to the Euclidian length of the straight line segment along the flat plane of the input image.

3. The system according to claim 2, wherein each input coordinate in the set of input coordinates is part of at least one respective pair of input coordinates, and adapted into a corresponding pair of output coordinates.

4. The system according to claim 2, wherein the set of output coordinates is adapted with respect to the set of input coordinates to minimize an overall distortion between the respective lengths of the curved line segment relative to the respective lengths of the straight line segments.

5. The system according to claim 2, wherein one of the geodesic length and the Euclidian length is scaled by an overall scaling parameter which is the same for the calculation of all output coordinates.

6. The system according to claim 2, wherein the three-dimensional curvature of the curved surface is mapped using parameterized line segments such as splines.

7. The system according to claim 6, wherein the curvature map is a non-uniform rational basis spline, NURBS, surface.

8. The system according to claim 1, comprising a scanner configured to scan the three-dimensional curvature of the curved surface for determining the curvature map.

9. The system according to claim 8, wherein the scanner is configured to scan a scanner beam over the curved surface, and determine the three-dimensional curvature based on the scanner beam.

10. The system according to claim 9, wherein the scanner beam is scanned using the same beam steering optics as used for projecting the laser beam onto the curved surface, wherein the scanner beam is scanned over the curved surface to determine the curvature map prior to applying the marking onto the curved surface based on the determined curvature map.

11. The system according to claim 1, wherein the optical assembly comprises focusing optics configured to focus the laser beam onto the curved surface, wherein the focusing optics comprise at least one spherical optical element configured to introduce spherical aberrations into the focused laser beam, wherein the spherical aberrations are configured to maximize a length of a focal region of the focused laser beam such that the focal region coincides with the curved surface for each position of the beam as determined by the beam steering optics.

12. The system according to claim 11, wherein the focusing optics comprise at least a first optical element having at least one spherical surface introducing a first set of spherical aberrations into the beam, and a second optical element having at least one spherical surface introducing second set of spherical aberrations into the beam, wherein the second optical element is arranged at a distance from the first optical element, wherein the sets of spherical aberrations are tuned to mutually interfere for maximizing the length of the focal region.

13. A method for marking a curved surface, the method comprising
using an optical assembly to project a laser beam onto the curved surface for applying the marking,
wherein the optical assembly comprises beam steering optics configured to determine a variable position at which the projected laser beam intersects the curved surface;
using a beam controller to control the beam steering optics based on a control algorithm;
wherein the control algorithm is configured to
receive an input image comprising a set of two-dimensional input coordinates representing nodes of the marking as it is intended to appear on the curved surface,
receive a curvature map representing a three-dimensional curvature of the curved surface,
calculate a set of two-dimensional output coordinates based on the set of two-dimensional input coordinates and the curvature map, wherein, in said calculation, the set of two-dimensional output coordinates is adapted with respect to the set of input coordinates to compensate for a distortion of relative distances between the nodes in the projecting of the laser beam onto the curved surface, and
control the position of the laser beam based on the set of the two-dimensional output coordinates.

14. A non-transitory computer-readable medium storing instructions including a control algorithm that, when executed by the beam controller of a laser marking system of claim 1, causes the beam controller to
receive an input image comprising a set of two-dimensional input coordinates representing nodes of the marking as it is intended to appear on the curved surface,
receive a curvature map representing a three-dimensional curvature of the curved surface,
calculate a set of two-dimensional output coordinates based on the set of two-dimensional input coordinates and the curvature map, wherein, in said calculation, the set of two-dimensional output coordinates is adapted with respect to the set of input coordinates to compensate for a distortion of relative distances between the nodes in the projecting of the laser beam onto the curved surface, and
control the position of the laser beam based on the set of the two-dimensional output coordinates.
